(19) United States
(12) Patent Application Publication
(10) Pub. No.: US 2016/0282274 A1
(43) Pub. Date: Sep. 29, 2016

(54) Large Area Mesoporous Silica Thin Film with Perpendicular Nanochannels on a Substrate and Process of forming the same

(71) Applicant: National Taiwan University, Taipei (TW)

(72) Inventors: Chung-Yuan Mou, Taipei (TW); Kun-Che Kao, Taipei (TW); Tzu-Ying Chen, Taipei (TW); Yi-Wen Wang, Taipei (TW); Yi-Hsin Liu, Taipei (TW)

(21) Appl. No.: 15/059,526

(22) Filed: Mar. 3, 2016

Related U.S. Application Data
(60) Provisional application No. 62/136,649, filed on Mar. 23, 2015.

(51) Int. Cl. G01N 21/65; C01B 33/12

(52) U.S. Cl. CPC G01N 21/658; C01B 33/124; C01P 2006/16; C01P 2004/03; C01P 2002/80; C01P 2004/04; G01N 2201/068

(57) ABSTRACT

The present invention disclosed a mesoporous silica thin film with perpendicular nanochannels on a substrate, a process of forming the same and the application in surface-enhanced Raman spectroscopy. Furthermore, a gold nanoparticle array on a mesoporous silica material with perpendicular nanochannels and the process of forming the same is also present in the invention.

### TECHNICAL FIELD OF THE INVENTION

The present invention relates to a mesoporous silica thin film (MSTF) with perpendicular nanochannels on a substrate, a process of forming the same and application thereof. Furthermore, a gold nanoparticle array on a mesoporous silica material with perpendicular nanochannels is also present in the invention.

### BACKGROUND OF THE INVENTION

Micelle-templated mesoporous silica has been study for its wide range of utilities as catalyst supports and biomedical nanocarriers and in membrane separation. It is stable at high temperatures and over a range of low pH values, and it allows for versatile surface functionalization. In many applications, thin-film morphology of such materials would be most helpful. However, sol-gel synthesis of mesoporous silica thin films (MSTF)using surfactant templating typically leads to parallel pore orientation with respect to the substrate surface, making the pores inaccessible.

On the other hand, in applications such as membrane separation, masks for electronic nanocomposites, and sensors, vertical orientation of the mesopores would be most desirable. Perpendicular orientation in such mesostructures with defect-free ordering on large length scales still remains a major research challenge. An obvious approach for aligning the orientation of mesopores is by some kind of directional external perturbation force. Several strategies have been developed for making mesoporous thin films with perpendicular orientation, including using high magnetic field, electrochemical assistance, epitaxy growth, evaporation-induced self-assembly (EISA), and air flow. However, the effect on the orientation was often only partial; lack of homogeneity over large substrate areas prevents widespread application. Fundamentally, the difficulty in vertical orientation lies mainly in the fact that the interactions of the film with the two boundary interfaces (substrate and air or water) are dissimilar.

Che et al., (Chem. Mater. 2011, 23, 3583) and Zhao et al., (Angew. Chem., Int. Ed. 2012, 51, 2173) taught methods of making mesoporous silica films with perpendicular channels on silicon and glass with Stöber-like solution, e.g., with water/ethanol mixture and highly alkalinic condition. However, the methods are limited to special surfactant or specific substrate. Therefore, we still do not have a general method that produces the desired thin-film morphology with perpendicular pores on large areas of various substrates.

Surface-enhanced Raman Scattering (SERS) is one of the most powerful analytic tools in label-free biosensing, and surface-enhanced spectroscopy. Localized electromagnetic(EM) fields are intensely enhanced at nanoscale “hot spots” in an assembly of noble metals to create gigantic field effects such as in SERS. A good SERS film substrate requires dense and well-controlled junction spots, large area and excellent spatial reproducibility. It is still a challenge in the fabrication of SERS substrates with well-controlled uniformly narrow gaps(sub-5 nm) of metal nanoparticles arrays in large area. Schlücker, S. (Angewandte Chemie International Edition. 2014, 53, 4756) taught that the field enhancement in SERS increases sharply for nanoparticle separations below 3 nm.

Based on the aforementioned, the important target of current industries is to develop a mesoporous silica thin film (MSTF) with perpendicular nanochannels on a substrate, the related process that can simply form the same and the application in spectroscopy analysis, such as surface enhanced Raman spectroscopy.

### SUMMARY OF THE INVENTION

The present invention disclosed a mesoporous silica thin film with perpendicular nanochannels on a substrate, a process of forming the same and application thereof. Furthermore, a gold nanoparticle array on a mesoporous silica material with perpendicular nanochannels is also present in the invention.

In one aspect, the present invention disclosed a process of forming a mesoporous silica thin film (MSTF) with perpendicular nanochannels on a substrate, said process comprises the following steps:

(1). Provide a substrate. (2). Provide an ammonia solution that comprises a tertiary alkyl ammonium halide, alcohol, and an additive. (3). Immerse the substrate into the ammonia solution. (4). Introduce a silica precursor into the ammonia solution and then perform a heating step to form a mesoporous silica thin film with perpendicular nanochannels on the substrate.

The aforementioned process further comprises a washing step. The washing step is a substrate-washing step and is to stabilize the mesoporous silica thin film with perpendicular nanochannels on the substrate by using a buffer. The buffer comprises HF/NH₄F. Preferably, the buffer is 0.025 weight percentage (wt %) of HF/NH₄F.

The aforementioned mesoporous silica thin film with perpendicular nanochannels have a film thickness between 20 nm and 100 nm, a pore diameter of the perpendicular nanochannels which is between 2 nm and 10 nm and an area more than 500 um×500 um in SEM analysis.

In one aspect, the present invention disclosed a mesoporous silica thin film with perpendicular nanochannels. The mesoporous silica thin film with perpendicular nanochannels have a film thickness between 20 nm and 100 nm, a pore diameter of the perpendicular nanochannels which is between 2 nm and 10 nm, and a two-dimensions (2D) hexagonal packing diffraction pattern with the space group of p6mm in fast Fourier transform (FFT-SEM) analysis.

In one aspect, the present invention also disclosed a process of making a gold nanoparticle array on a mesoporous silica material with perpendicular nanochannels, the process comprises the following steps

(1). Provide a mesoporous silica material with perpendicular nanochannels selected from one of the group consisting of a mesoporous silica thin film and a mesoporous silica nanoparticle. (2). Perform a reaction to have the mesoporous silica material with perpendicular nanochannels react with an amino functional group introducing agent to give a amino functionalized mesoporous silica material with perpendicular nanochannels. (3). Immerse the amino functionalized mesoporous silica material with perpendicular nanochannels into a gold precursor solution to coat gold ions onto the amino functionalized mesoporous silica material with perpendicular nanochannels, and then perform a reduction reaction to reduce the gold ions to gold nanoparticles, so as to form the gold nanoparticle array on the mesoporous silica material with perpendicular nanochannels. The gold nanoparticle directly anchored on the perpendicular nanochannels, and a pore diameter of the perpendicular nanochannels is between 2 nm and 10 nm.

In another aspect, the present invention disclosed a gold nanoparticle array. The gold nanoparticle array consists of gold nanoparticles and a mesoporous silica material with perpendicular nanochannels, wherein the gold nanoparticles directly anchored on the perpendicular nanochannels and gap distances between the gold nanoparticles on the mesoporous silica material with perpendicular nanochannels is less than 3 nm.

In still another aspect, a method for detecting a molecule by surface-enhanced Raman spectroscopy is also provided, the method comprises the following steps:

Provide gold nanoparticle arrays on a mesoporous silica material with perpendicular nanochannels selected from one of the groups consisting of a mesoporous silica thin film (MSTF) and mesoporous silica nanoparticles (MSNs), and detect a molecule adsorbing onto the gold nanoparticle arrays on the mesoporous silica material with perpendicular nanochannels by surface-enhanced Raman spectroscopy.

The aforementioned method is able to detect a concentration of the molecule less than or equal to 100 uM.

In conclusion, the present invention disclosed a mesoporous silica thin film with perpendicular nanochannels on a substrate, a process of forming the same and the application in surface-enhanced Raman spectroscopy. Furthermore, a gold nanoparticle array on a mesoporous silica material with perpendicular nanochannels and the process of forming the same is also present in the invention.

### BRIEF DESCRIPTION OF THE DRAWINGS

FIG. 1(a) illustrates Low-magnification top-view SEM image of MSTFs near a cutting edge, FIG. 1(b) illustrates cross-sectional SEM image, FIG. 1(c) illustrates top-view SEM image with its FFT pattern, and FIG. 1(d) illustrates TEM image of highly ordered MSTF/Si microtomed specimen prepared by focused ion beam (FIB). Surfactants are extracted with HCl-ethanol;

FIG. 2(a) illustrates GISAXS pattern of nd-MSTF on Si wafer, FIG. 2(b) illustrates top-view SEM image of nd-MSTF on Si wafer, FIG. 2(c) illustrates GISAXS pattern of MSTF/Si wafer with introduction of decane and FIG. 2(d) illustrates top-view SEM image of MSTF/Si wafer with introduction of decane;

FIG. 3(a) illustrates Top-view SEM images of MSTFs made of tetraethyl orthosilicate (TEOS), FIG. 3(b) illustrates Top-view SEM images of MSTFs made of fumed silica, FIG. 3(c) illustrates Top-view SEM images of MSTFs made of zeolite beta seeds, FIG. 3(d) illustrates MSTFs individually grown on piranha-treated Si wafers, FIG. 3(e) illustrates tert-butyltrichlorosilane-functionalized Si wafers, and FIG. 3(f) illustrates polystyrene-coated Si wafers;

FIG. 4(a) illustrates Ex situ GISAXS signals of MSTF/Si wafers during alignment process, FIG. 4(b) illustrates In-plane line cut signals from ex situ GISAXS signals of MSTF/Si wafers synthesized at (i) 5.8, (ii) 40, (iii) 120, and (iv) 360 min and FIG. 4(c) illustrates Increment of in-plane d₁₀₀-spacings (nm) in time (min);

FIG. 5 illustrates Digital-photo images of mesoporous silica thin film growing on a centimeter-wide Si wafer;

FIG. 6(a) illustrates Cross-sectional SEM images of MSTF with decane at reaction time of 5 min, FIG. 6(b) illustrates Cross-sectional SEM images of MSTF with decane at reaction time of 15 min, FIG. 6(c) illustrates Cross-sectional SEM images of MSTF with decane at reaction time of 30 min, FIG. 6(d) illustrates Cross-sectional SEM images of MSTF with decane at reaction time of 120 min, FIG. 6(e) illustrates Cross-sectional SEM images of MSTF with decane at reaction time of 360 min and FIG. 6(f) illustrates the statistic results of these thicknesses variations up to 23 h;

FIG. 7(a) illustrates a cross sectional TEM image of MSTF with decane and FIG. 7(b) illustrates TEM contrast analysis of ten consecutive slabs within the blue box area. The white image resulting in higher counts in intensity (peaks in b) represents pore space (5.7±0.5 nm). The gray image resulting in lower counts in intensity (valleys in b) represents silica wall (2.1±0.4 nm). Boundaries between pores and walls are defined from the peak widths at their half maximum heights;

FIG. 8(a) illustrates Cross-sectional SEM image of MSTF without decane at reaction time of 15 min, FIG. 8(b) illustrates Cross-sectional SEM image of MSTF without decane at reaction time of 30 min, FIG. 8(c) illustrates Cross-sectional SEM image of MSTF without decane at reaction time of 120 min, FIG. 8(d) illustrates Cross-sectional SEM image of MSTF without decane at reaction time of 360 min and FIG. 8(e) illustrates the statistic results of these thicknesses from above samples;

FIG. 9(a) illustrates Corresponding out-of-plane (q_{z}) and in-plane (q_{y}) converted line cut signals from GISAXS image patterns of nd-MSTF shown in FIG. 2(a), and FIG. 9(b) illustrates Corresponding out-of-plane (q_{z}) and in-plane (q_{y}) converted line cut signals from GISAXS image patterns of MSTF synthesized with introduction of decane shown in FIG. 2(c);

FIG. 10(a) illustrates SEM images of MSTFs from Ethyl acetate (pore diameters: 3.0±0.5 nm) grown on Si wafers, FIG. 10(b) illustrates SEM images of MSTFs from Hexadecane (pore diameters: 3.5±0.4 nm) grown on Si wafers, FIG. 10(c) illustrates SEM images of MSTFs from Petroleum ether (pore diameters 4.9±1.2 nm) grown on Si wafers, and FIG. 10(d) illustrates SEM images of MSTFs from Pentyl ether (pore diameters: 6.6±1.5 nm) grown on Si wafers;

FIG. 11(a) illustrates Top-view SEM images of typical MSTFs grown on ethanol (contact angles: 62.2°) treated Si wafers, FIG. 11(b) illustrates Top-view SEM images of typical MSTFs grown on HF (contact angles: 82.6°) treated Si wafers, and FIG. 11(c) illustrates Top-view SEM images of typical MSTFs grown on trimethylchlorosilane (contact angles: 98.4°) treated Si wafers, FIG. 11(d) illustrates Top-view SEM images of typical MSTFs grown on indium tin oxide (ITO), FIG. 11(e) illustrates Top-view SEM images of typical MSTFs grown on fluorine doped tin oxide (FTO), FIG. 11(f) illustrates Top-view SEM images of typical MSTFs grown on sapphire surfaces;

FIG. 12(a) illustrates Cross-sectional SEM images of MSTFs synthesized with 0.3 M of ammonia solution, FIG. 12(b) illustrates Cross-sectional SEM images of MSTFs synthesized with 0.6 M of ammonia solution, FIG. 12(c) illustrates Cross-sectional SEM images of MSTFs synthesized with 0.9 M of ammonia solution and FIG. 12(d) illustrates a plot of MSTFs thickness as a function of ammonia concentration;

FIG. 13(a) illustrates representative SEM images of APTMS-functionalized MSTF, FIG. 13(b) illustrates High-magnification SEM images of MSTF-Au, FIG. 13(c) illustrates low-magnification SEM images of MSTF-Au, FIG. 13(d) illustrates representative SEM images of spin-coated MSN on silicon wafers, FIG. 13(e) illustrates High-magnification SEM images of MSN-Au with high density of gold nanoparticles formed on the mesopores and FIG. 13(f) illustrates low-magnification SEM images of MSN-Au with high density of gold nanoparticles formed on the mesopores (Here, the gold nanoparticle arrays formed on MSTF and MSN were denoted as MSTF-Au and MSN-Au, respectively);

FIG. 14 illustrates UV-Vis absorption spectrum of gold nanoparticle solution (black) reduced by NaBH₄ without capping reagent, and dark-field scattering spectra of MSTF-Au (red) and MSN-Au (blue) on Si wafers;

FIG. 15(a) illustrates Raman spectra of R6G on MSTF-Au with a series of concentrations and FIG. 15(b) illustrates Raman spectra of R6G on MSN-Au with a series of concentrations. FIG. 15(c) illustrates Raman spectra of R6G (100 μM) on MSTF-Au at 8 different positions (distance=5 μm), and FIG. 15(d) illustrates SERS intensity plots of the 8 positions at 612 cm⁻¹, 772 cm⁻¹, and 1360 cm⁻¹ in (c). Relative standard deviations of the SERS signals at 612 cm⁻¹, 772 cm⁻¹, and 1360 cm⁻¹ are 5.1%, 4.7%, and 3.9%, respectively;

FIG. 16(a) illustrates Statistical analysis of mesopore size of MSTF in FIG. 13(a), FIG. 16(b) illustrates Statistical analysis of gold nanoparticle diameter on MSTF-Au in FIG. 13(b), and FIG. 16(c) illustrates Statistical analysis of gap distance between gold nanoparticles on MSTF-Au in FIG. 13(b);

FIG. 17(a) illustrates SEM images of bare MSTF after Au reduction, and FIG. 17(b) illustrates SEM images of APTMS-functionalized Si wafer after Au reduction. The Au reduction procedure is the same as that of APTMS-modified MSTF;

FIG. 18(a) illustrates a representative TEM image of MSN-Au scratched from Si wafer. The arrows indicates the locations of gold nanoparticles are mainly on the entrances of mesopores. FIG. 18(b) illustrates Size distributions of gold nanoparticles on MSN-Au deduced from FIG. 13(e) and FIG. 18 (c) illustrates gaps on MSN-Au deduced from FIG. 13(e);

FIG. 19(a) illustrates conventional Raman spectra of R6G on Si wafer (black), MSTF (red), and MSN (blue) after soaking in R6G aqueous solution at a concentration of 1 mM and FIG. 19(b) illustrates conventional Raman spectra of 4-MBA on Si wafer (black), MSTF (red), and MSN (blue) after soaking in 4-MBA methanol solution at a concentration of 1 mM;

FIG. 20(a) illustrates Raman spectra of 4-MBA on MSTF-Au with a series of concentrations and FIG. 20(b) illustrates Raman spectra of 4-MBA on MSN-Au with a series of concentrations.

### BRIEF DESCRIPTION OF THE PREFERRED EMBODIMENTS

In one embodiment, the present invention disclosed a process of forming a mesoporous silica thin film with perpendicular nanochannels on a substrate, said process comprises the following steps:

(1). Provide a substrate. (2). Provide an ammonia solution that comprises a tertiary alkyl ammonium halide, an alcohol, and an additive. (3). Immerse the substrate into the ammonia solution. (4). Introduce a silica precursor into the ammonia solution and then perform a heating step to form a mesoporous silica thin film with perpendicular nanochannels on the substrate.

The aforementioned process further comprises a washing step. The washing step is to stabilize the mesoporous silica thin film with perpendicular nanochannels on the substrate by using a buffer. The buffer comprises HF/NH₄F. Preferably, the buffer is 0.025 weight percentage (wt %) of HF/NH₄F.

In order to form a stable mesoporous silica thin film with perpendicular nanochannels, the concentration of the additive is between 0.001M and 0.3M. Preferably, the concentration of the additive is between 0.004M and 0.3M.

The aforementioned mesoporous silica thin film with perpendicular nanochannels have a film thickness between 20 nm and 100 nm, a pore diameter of the perpendicular nanochannels which is between 2 nm and 10 nm and an area more than 500 um×500 um in SEM analysis.

In one example of the embodiment, the substrate comprises a silicon wafer, a polystyrene-coated silicon wafer, a ceramic, aluminum oxide, tert-butyltrichlorosilane-functionalized Si wafer, indium tin oxide(ITO), fluorine doped tin oxide(FTO), sapphire surfaces and a conducting glass.

In one example of the embodiment, the additive is selected from one of the groups consisting of decane, ethyl acetate, petroleum ether, hexadecane, pentyl ether and the combination. Preferably, the concentration of the additive is between 0.001M and 0.3M.

In one example of the embodiment, ammonia concentration of the ammonia solution is between 0.05 and 1.5M.

In one example of the embodiment,the tertiary alkyl ammonium halide is cetyltrimethylammonium bromide.

In one example of the embodiment,the silica precursor comprises tetraethyl orthosilicate, fumed silica, and zeolite beta seeds.

In one embodiment, the present invention disclosed a mesoporous silica thin film with perpendicular nanochannels. The mesoporous silica thin film with perpendicular nanochannels have a film thickness between 20 nm and 100 nm, a pore diameter of the perpendicular nanochannels which is between 2 nm and 10 nm, and a two-dimensions (2D) hexagonal packing diffraction pattern with the space group of p6mm in FFT-SEM analysis.

In one example of the embodiment, the pore diameter of the perpendicular nanochannels is between 5 nm and 10 nm.

In one example of the embodiment, the mesoporous silica thin film with perpendicular nanochannels being on part or all of surfaces of a membrane.

In one example of the embodiment, the mesoporous silica thin film with perpendicular nanochannels being on part or all of surfaces of a semiconductor.

In one example of the embodiment, the mesoporous silica thin film with perpendicular nanochannels being on part or all of surfaces of a catalyst.

In one example of the embodiment, the mesoporous silica thin film with perpendicular nanochannels being on part or all of surfaces of a sensor.

In one example of the embodiment, the mesoporous silica thin film with perpendicular nanochannels being on part or all of surfaces of an energy conversion device.

In another embodiment of the invention, the present invention disclosed a process of making a gold nanoparticle array on a mesoporous silica material with perpendicular nanochannels. The gold nanoparticle array consist of a gold nanoparticle and a mesoporous silica material with perpendicular nanochannels, wherein the gold nanoparticles directly anchored on the perpendicular nanochannels and gap distances between the gold nanoparticles on the mesoporous silica material with perpendicular nanochannels is less than 3 nm. The process comprises the following steps

(1). Provide a mesoporous silica material with perpendicular nanochannels selected from one of the group consisting of a mesoporous silica thin film and a mesoporous silica nanoparticle. (2). Perform a reaction to have the mesoporous silica material with perpendicular nanochannels react with an amino functional group introducing agent to give a amino functionalized mesoporous silica material with perpendicular nanochannels. (3). Immerse the amino functionalized mesoporous silica material with perpendicular nanochannels into a gold precursor solution to coat gold ions onto the amino functionalized mesoporous silica material with perpendicular nanochannels, and perform a reduction reaction to reduce the gold ions to gold nanoparticles, so as to form the gold nanoparticle array on the mesoporous silica material with perpendicular nanochannels. The gold nanoparticles directly anchored on the perpendicular nanochannels, and a pore diameter of the perpendicular nanochannels is between 2 nm and 10 nm.

In one example of the another embodiment, the mesoporous silica nanoparticle is coated on a substrate which comprises Si-wafer by spin-coating.

In one example of the another embodiment, the gold nanoparticle has a diameter between 3 nm and 30 nm.

In one example of the another embodiment, gap distances between the gold nanoparticles on the mesoporous silica material with perpendicular nanochannels is less than 3 nm.

In one example of the another embodiment, the amino functional group introducing agent comprises (3-aminopropyl)trimethoxysilane.

In one example of the another embodiment, the gold precursor solution comprises HAuCl₄. Preferably, the concentration of HAuCl₄ is 0.01 mM-5 mM.

In one example of the another embodiment,the reduction reaction is performed with a hydride reducing reagent.

In one example of the another embodiment, the hydride reducing reagent comprises sodium borohydride. Preferably, the concentration of sodium borohydride is 0.1 mM-10 mM.

In one example of the another embodiment, the gold nanoparticle array on a mesoporous silica material with perpendicular nanochannels is applied in label-free chemical sensing and biosensing.

In one preferred example of the another embodiment, a silica surfaces were functionalized with a high density of (3-aminopropyl)trimethoxysilane (APTMS) in ethanol solution. From elemental analysis, the amount of APTMS grafted on mesoporous silica was calculated to be 2.53 mmol/g of SiO₂, equivalent to a high density of 1.43 APTMS nm⁻² which is close to monolayer coverage. Then, amine-functionalized mesoporous silica thin film or mesoporous silica nanoparticles were immersed in a HAuCl₄ aqueous solution at a pH value of 3.2. The presence of high density positively charged amine groups on silica surfaces essentially enhanced the adsorption of negatively charged gold precursor (AuCl₄⁻) into the nanochannels through electrostatic interaction. Sequentially, with the introduction of NaBH₄, gold nanoparticles were uniformly reduced on the mesopores forming gold nanoparticle arrays.

In another embodiment of the invention, the invention disclosed a gold nanoparticle array. The gold nanoparticle array consist of a gold nanoparticle and a mesoporous silica material with perpendicular nanochannels, wherein the gold nanoparticles directly anchored on the perpendicular nanochannels and gap distances between the gold nanoparticles on the mesoporous silica material with perpendicular nanochannels is less than 3 nm.

In one example of the another embodiment, the mesoporous silica material with perpendicular nanochannels is selected from one of the groups consisting of a mesoporous silica thin film and a mesoporous silica nanoparticle.

In one example of the another embodiment, the gold nanoparticle has a diameter between 3 nm and 30 nm.

In one example of the another embodiment, a pore diameter of the perpendicular nanochannels is between 2 nm and 10 nm.

In one example of the another embodiment, the aforementioned gold nanoparticle array is applied in label-free chemical sensing and biosensing.

In still another embodiment of the invention, a method for detecting a molecule by surface-enhanced Raman spectroscopy is also provided, the method comprises the following steps:

Provide gold nanoparticle arrays on a mesoporous silica material with perpendicular nanochannels selected from one of the groups consisting of a mesoporous silica thin film and a mesoporous silica nanoparticle, and detect a molecule adsorbing onto the gold nanoparticle arrays on the mesoporous silica material with perpendicular nanochannels by surface-enhanced Raman spectroscopy.

The aforementioned method is able to detect a concentration of the molecule less than or equal to 100 uM.

In the present invention, the on-substrate mesoporous silica templated gold nanoparticle arrays are directly employed for surface-enhanced Raman spectroscopy (SERS) applications without transferring procedures.

The present on-substrate 2 dimensions (2-D) closely packed gold nanoparticles with gap distances between the gold nanoparticles about 3 nm created strong SERS-active sites and this are very suitable for label-free chemical sensing. Herein, the gap distances between the gold nanoparticles is about 3 nm is defined to a “nanogap” in the present invention. In addition, because of none of introduction of capping reagent during the synthesis of the gold nanoparticle arrays, analyzed molecules efficiently adsorbed on the organic free gold surfaces.

In one example of this embodiment, the molecule comprises rhodamine 6G, rhodamine B (RhB) and 4-Mercaptobenzoic acid.

In one example of this embodiment, the gold nanoparticles directly anchor on the perpendicular nanochannels and gap distances between the gold nanoparticles on the mesoporous silica material with perpendicular nanochannels are less than 3 nm.

In one example of this embodiment, the mesoporous silica material with perpendicular nanochannels is part of a sample carrier.

In one example of this embodiment,the gold nanoparticle arrays on the mesoporous silica material with perpendicular nanochannels is the gold nanoparticle array on mesoporous silica thin film (MSTF-Au).

In one example of this embodiment,the gold nanoparticle array on mesoporous silica thin film is use as the sample carrier. The detection limit of rhodamine 6G is down to 1 nM in surface enhanced Raman spectroscopy.

In accordance with the foregoing summary, the following presents a detailed description of the example in the present invention. However, this invention is applied extensively to other embodiments and the scope of this present invention is expressly not limited except as specified in the accompanying claims.

In conclusion, the present invention disclosed a mesoporous silica thin film with perpendicular nanochannels on a substrate, a process of forming the same and the application in surface-enhanced Raman spectroscopy. Furthermore, a gold nanoparticle array on a mesoporous silica material with perpendicular nanochannels and the process of forming the same is also present in the invention.

### EXAMPLE 1

### Synthesis of Mesoporous Silica Thin Films (MSTF)

In a typical synthesis, an oil-in-water emulsion was prepared by mixing cetyltrimethylammonium bromide (CTAB) (0.193 g), ethanol (6.0 g) and decane (75-600 μL) in NH₃ aqueous solution (0.1-0.9 M, 80 g) at 50° C. Then, a polished silicon or indium tin oxide (ITO) wafer was directly immersed into the solution, followed by an introduction of tetraethyl orthosilicate(TEOS)/ethanol solution (2.0 mL, 20% by volumes) under stirring at 50° C. overnight. The molar ratios of CTAB:H₂O:NH₃:decane:ethanol:TEOS were calculated to be 1:8400:90:5.8:250:2.8. The synthesized MSTFs on substrates were purge with N₂ to dry the substrate surface prior to SEM and GISAXS analyses. MSTF specimens for replica experiments were prepared by ethanol rising and calcination in the air at 500° C. for 6 h to remove organic surfactants. For the syntheses using other silica sources, TEOS was replaced by fumed silica and β-zeolite seeds with the same molar ratio. The β-zeolite seeds (Si/Al=66) were prepared by mixing NaAlO₂ (0.25 g), fumed silica (12 g), tetraethylammoniumhydroxide (TEAOH) (39 g), and NaOH (0.6 g) in H₂O (32.4 g) under stirring at 50° C. for 6 h. Then, the mixture was hydrothermally treated at 110° C. in an autoclave.

### EXAMPLE 2

### Modification of MesoporousSilicaThin Films

For the modification of APTMS, calcined MSTF was shaken in an APTMS/ethanol solution (1%, v/v) at room temperature for 16 h. Then, APTMS-modified MSTF was rinsed with ethanol several times and was dried in vacuum.

### EXAMPLE 3

### Syntheses and functionalization of Mesoporous Silica Nanoparticle(MSN)

For the synthesis of MSN (pore size ˜6 nm), the CTAB/H₂O/decane/ethanol emulsion was stirred at 50° C. for 12 h before the introduction of NH₃ solution (1.5 g, 35 wt %) and TEOS/ethanol solution (1.67 mL, 20% v/v). The mixture was stirring at 50° C. for 1 h, and then aged at 50° C. for 20 h. As-synthesized products were filtered with a filter paper to remove side products formed on the oil-water interfaces. Filtrate MSN solution was then hydrothermally treated in an autoclave at 80° C. for 24 h. To remove organic surfactants, MSNs were treated with an HCl/ethanol (5 mg/ml) solution at 60° C. for 2 h twice, followed by centrifugation and sonication with ethanol times. For the modification of APTMS, MSNs were suspended in an APTMS/ethanol (1%, v/v) and refluxed at 90° C. for 16 h. Functionalized MSNs were centrifuged and sonicated with ethanol 5 times, and then stored in ethanol. For spin-coating, 100 μl of APTMS-functionalized MSN/ethanol solution (2.5 mg/ml) was deposited on a silicon wafer (10×10 mm²), and spin-coated using a spinner at 800 rpm for 60 s. Then, spin-coated samples were dried in vacuum overnight.

Characterization of the Mesoporous Silica Structure

Scanning Electron Microscope (SEM).

Top-view and edge-view micrographs were taken on a field emission scanning electron microscope (Hitachi S-4800) operated at accelerating voltages of 5 kV and 15 kV, respectively. The MSTF specimen was loaded onto a plate holder with conducting carbon tape adhered at the bottom and silver paint coated at the edges of wafers. The whole specimen was baked at 80° C. overnight prior to SEM imaging.

Focus Ion beam (FIB) for cross sectional micrograph Cross-sectional specimens were prepared by focus ion beam and electron beam systems (FIB/SEM, JEOL JIB-4500 and FEI Nova 200 Dual Beam). The thin film samples were deposited with a thick layer of amorphous carbon for specimen protection. The ion source (gallium) accelerated at a voltage of 5-30 kV was employed to cut thin film into slice samples with dimensions of 100×100×50 nm³ inside the FIB chamber. The slice was laid down on a copper grid with the film lateral orientation parallel to the cross sectional view under TEM imaging.

Transmission Electron Microscope (TEM)

The cross sectional micrograph was taken on a transmission electron microscope (Hitachi H-7100) with an accelerating voltages of 200 kV.

Grazing Incidence Small Angle X-Ray Scattering (GISAXS).

The incidence X-ray energy of 12 keV (1.033 Å) and the sample-to-detector distance of 3.10 m result in a q-range of 0.005540-0.2853 Å⁻¹ that is equivalent to real space distance of 2.2-113 nm. The angle of incidence of each X-ray beam varied between 0.1 and 0.3°. The scattering data extraction was performed in an X-ray scattering image analysis package (POLAR). Alternatively, in-house scattering was conducted by a grazing-incidence geometry (Nano-Viewer, Rigaku) with a two-dimensional (2D) area detector (Rigaku, 100K PILATUS). The instrument is equipped with a 31 kW mm⁻² generator (rotating anode X-ray source with a Cu Kα radiation of λ=0.154 nm). The scattering vector, q (q=4π/λ sin θ), along with the scattering angles θ in these patterns were calibrated using silver behenate. The mesoporous silica thin film with perpendicular nanochannels were mounted on a z-axis goniometer with an incident angle of 0.1-0.3°.

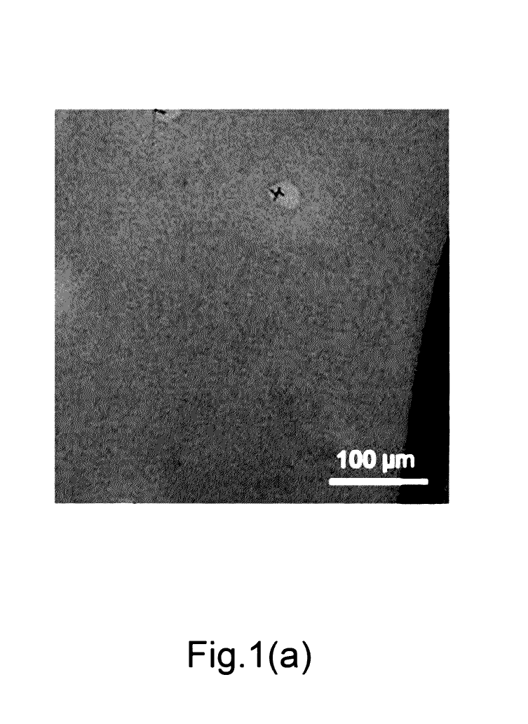

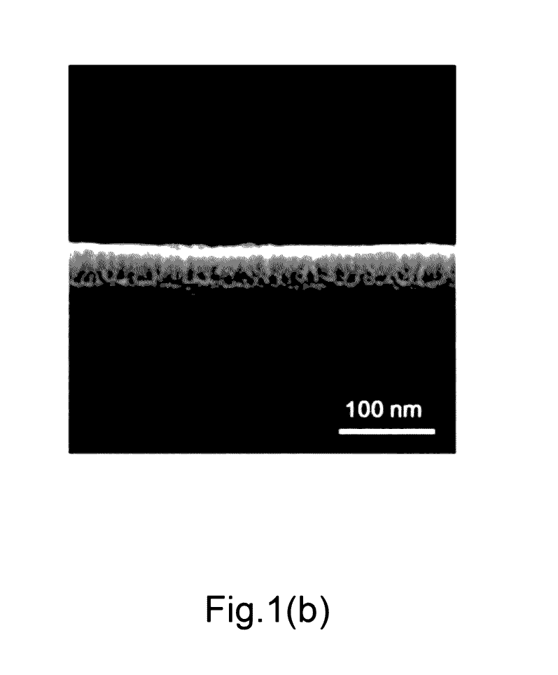

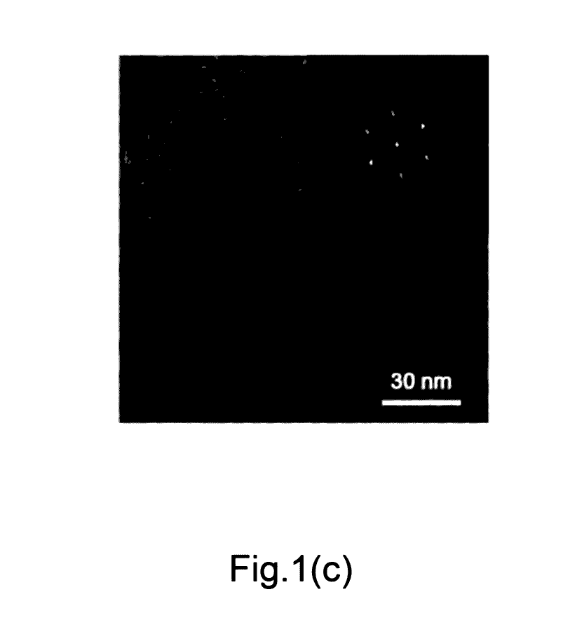

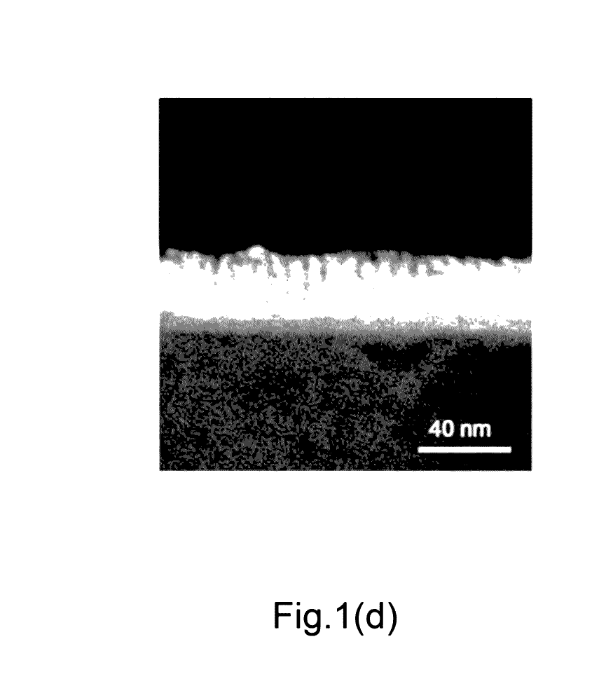

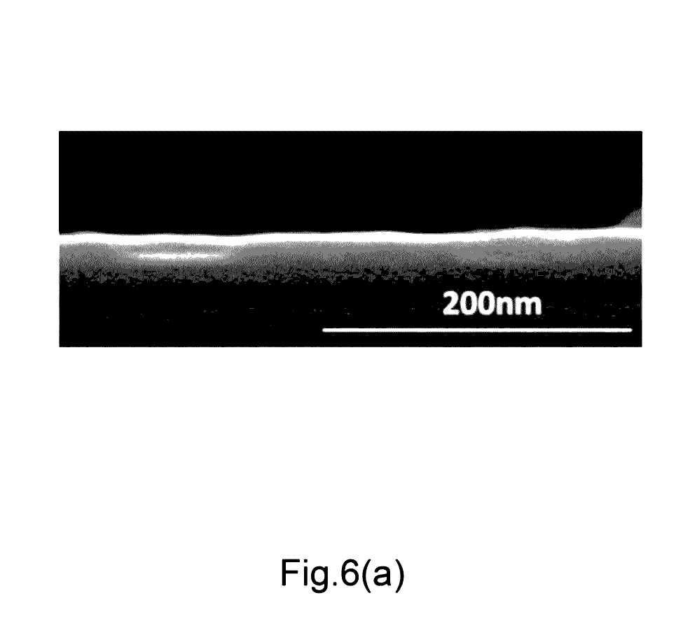

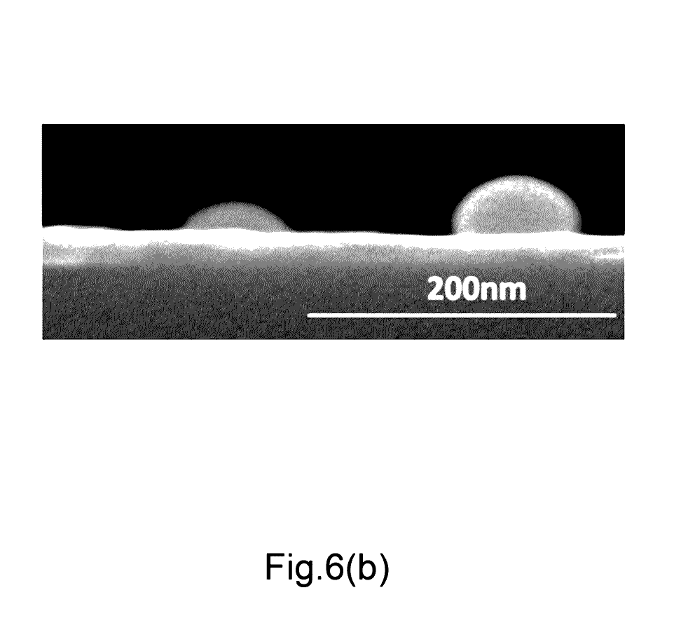

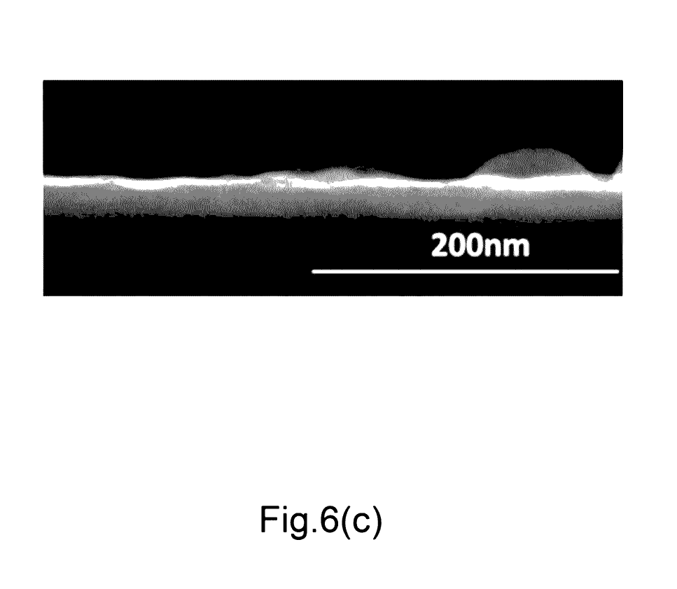

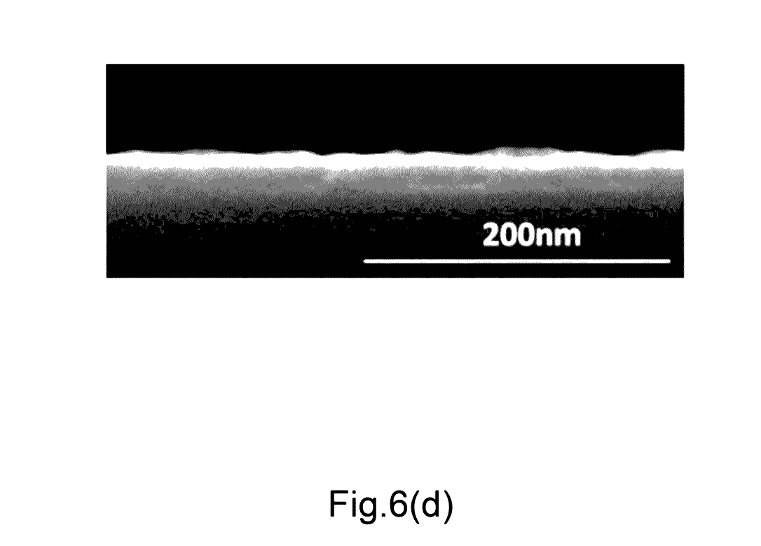

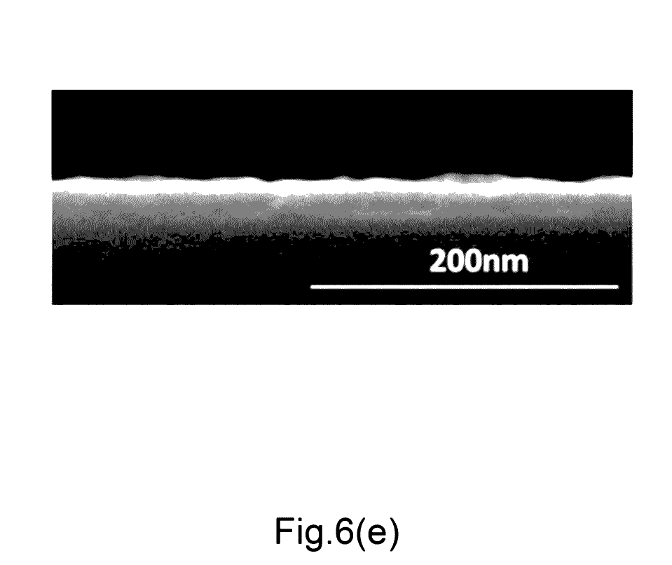

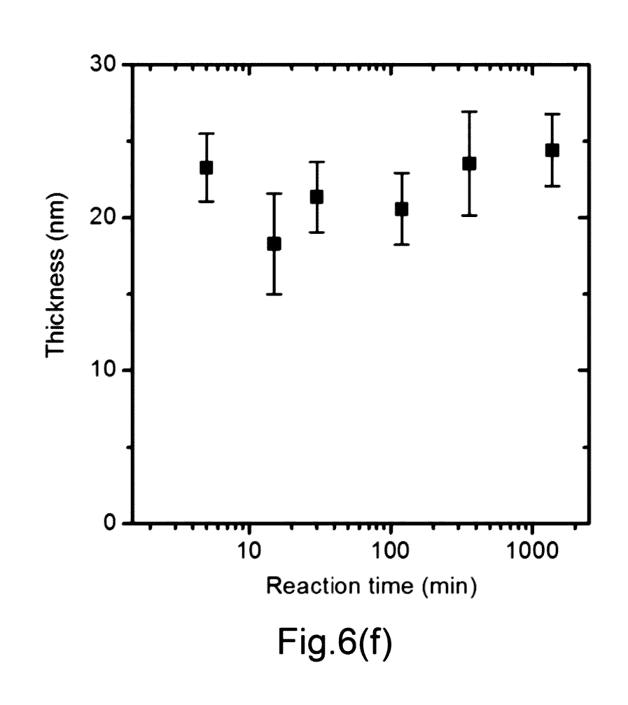

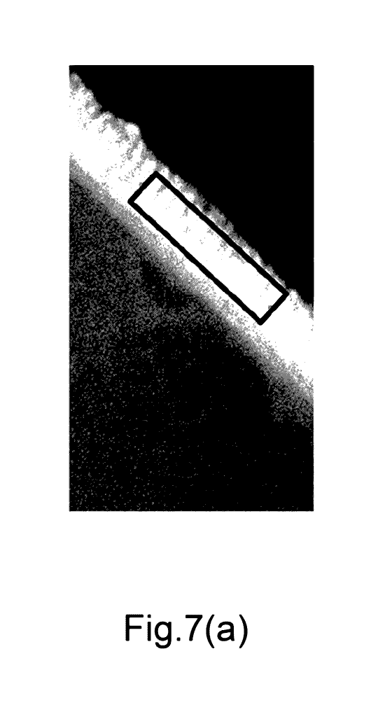

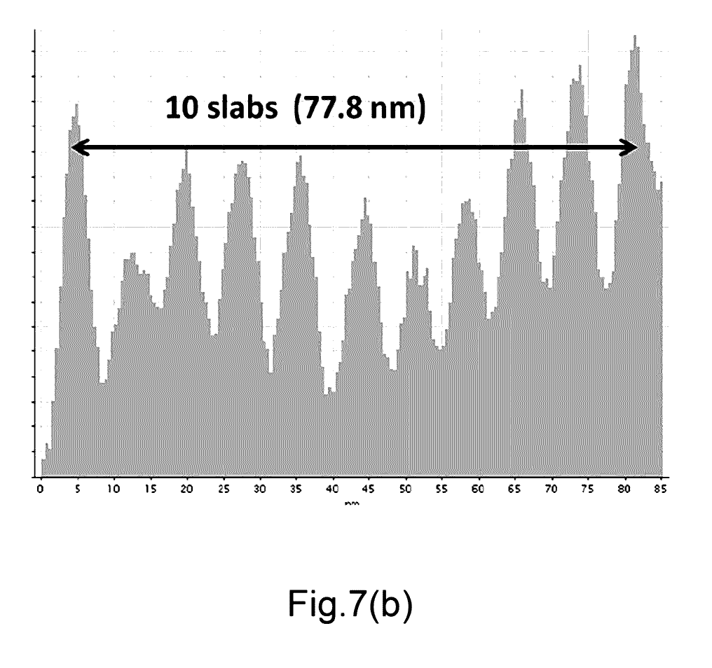

At low magnification, a top-view SEM image (FIG. 1(a)) confirms a continuous regime of MSTF without apparent defects after extraction of solvent or calcination. In fact, centimeter-size MSTFs on Si wafers with optically uniformity can be made routinely. A side-view SEM image of the MSTF (FIG. 1(b)) shows perpendicular channels of uniform thickness (30 nm). SEM images of mesoporous thin films at different reaction times, from 5 to 360 min, show that the maximum thickness is reached within the first 15 min and remains constant thereafter (FIG. 6). A top-view SEM image (FIG. 1(c)) shows nearly perfect hexagonally arranged nanopores. A fast Fourier transform (FFT) pattern from the top-view SEM image(FIG. 1(c)) reveals a 2D hexagonal packing diffraction pattern with the space group of p6mm. A cross-sectional TEM image(FIG. 1(d)) from a microtomed specimen further confirms vertical channels with sub-10 nm pore diameters. TEM contrast analysis of 10 consecutive slabs of white and gray stripes gives an averaged pore spacing of 7.78 nm (FIG. 7), pore diameter of 5.7±0.5 nm, and pore-wall thickness of 2.1±0.4 nm.

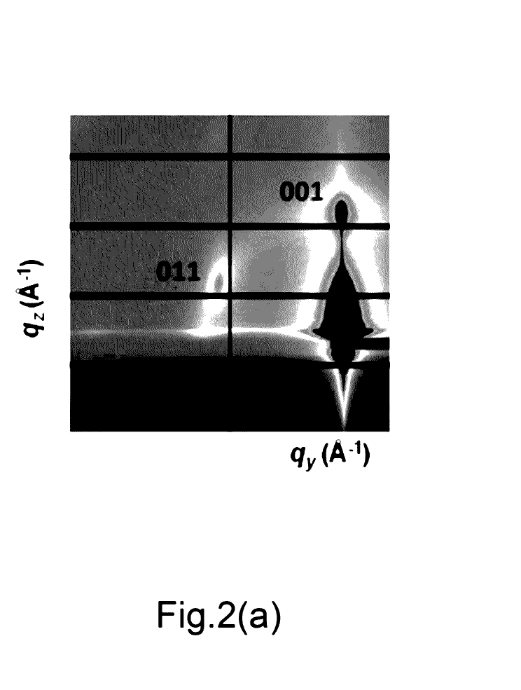

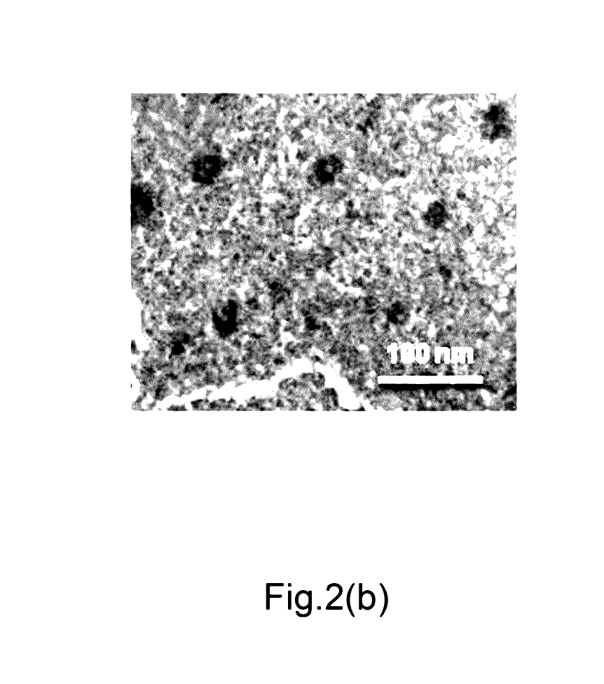

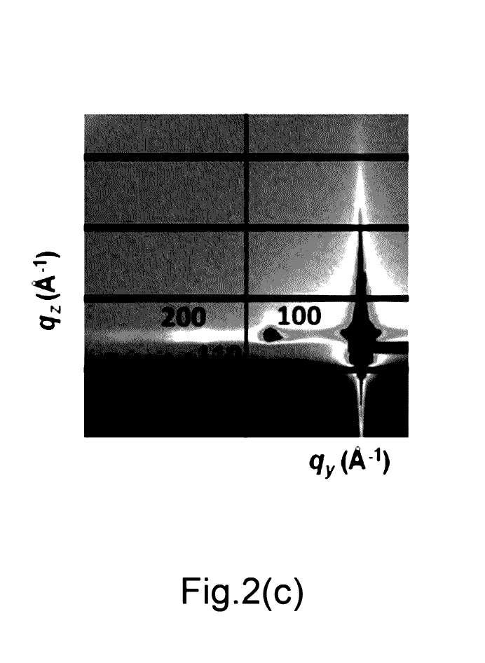

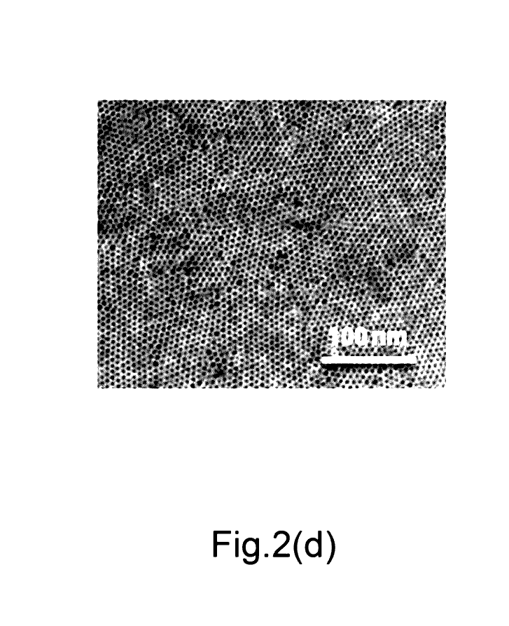

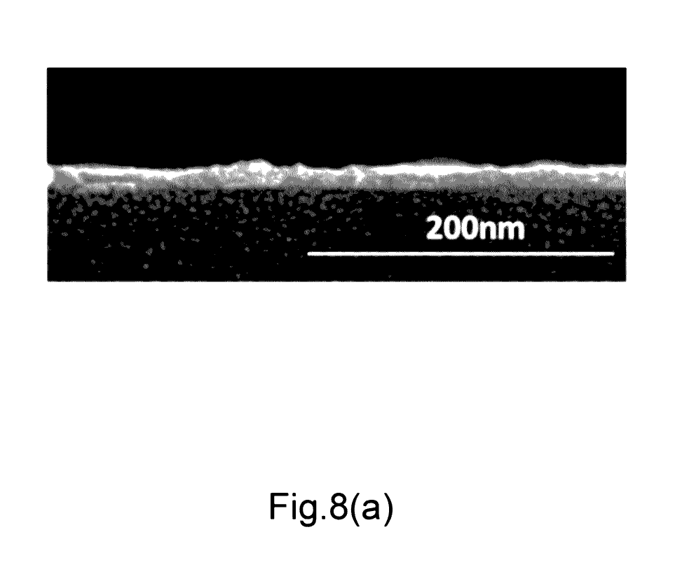

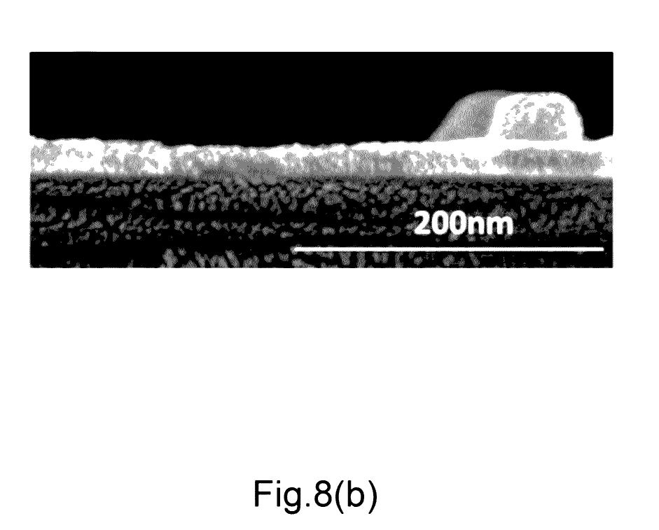

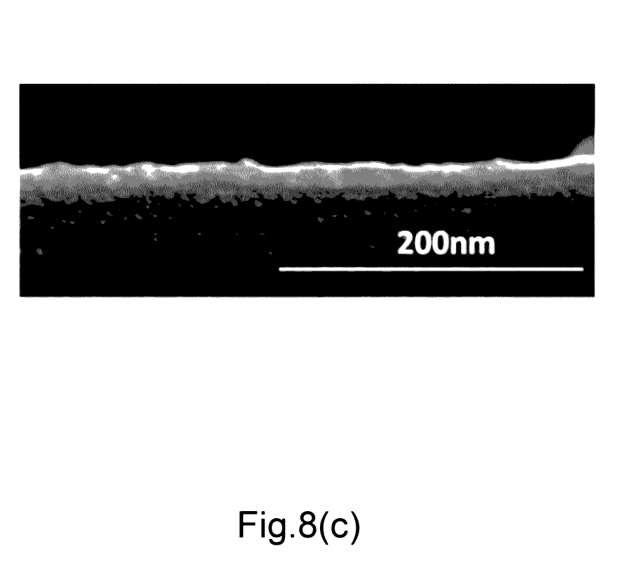

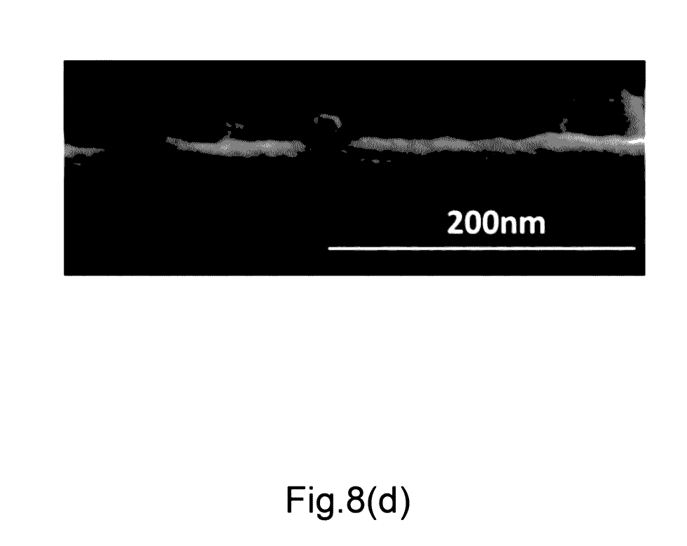

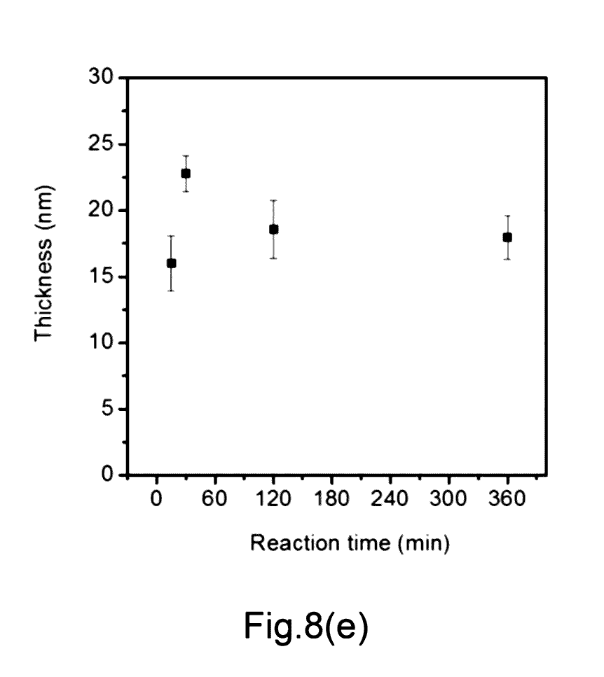

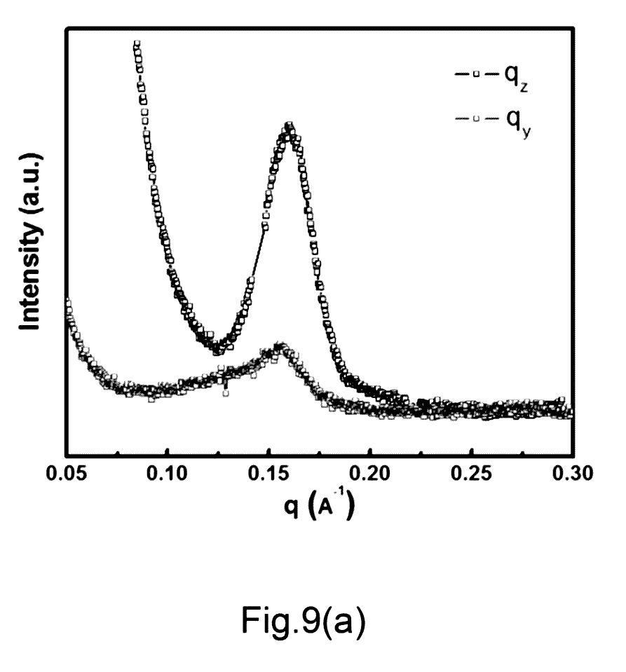

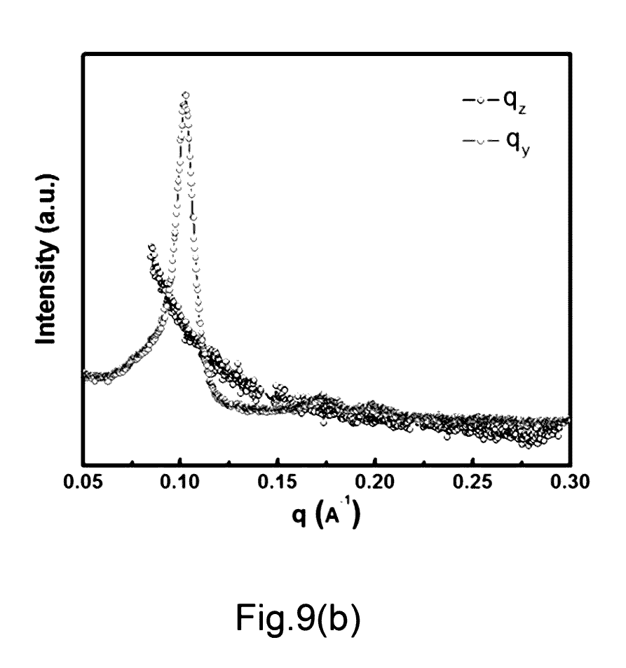

FIG. 2 shows the unique role of decane in the formation of perpendicular nanochannels of MSTFs. With other conditions being the same, when decane was not added in the synthesis (nd-MSTF), random orientations of nanochannels were obtained (FIG. 2(a)). Top-view and cross-sectional SEM images (FIG. 2(b) and FIG. 8) of the thin film show no clear orientation of the nanochannels. Apparently, the orientations of pores were too random to be observed. Much broadened GISAXS profiles, both in-plane and out-of-plane (FIG. 9(a)), with short coherence lengths (49.6 and 53.2 nm for z,x- and y-direction, respectively), indicate random orientations of nanochannels in the film.

With decane added in synthesis, vertical nanochannels features of mesoporous thin films are quite obvious from in-plane Bragg peaks in GISAXS patterns (FIG. 2(c)), showing sharp diffraction profiles of appreciable 3-5 hexagonal reflections and a corresponding large coherence length (140.1 nm, FIG. 9(b)). In addition, these reflection features were not altered by varying X-ray incident angles) (0.1°-0.3°) which further suggests ensemble uniformity of the hexagonal alignment along the vertical direction. The expanded mesopores with highly ordered periodicity are routinely evidenced in the top-view SEM image (FIG. 2(d)), with average pore size of 5.7 nm and pore-to-pore distance of 7.6 nm, in agreement with TEM observation (FIG. 7). Decane obviously plays a decisive role in creating vertical orientation as well as expanding pore diameters during the co-assembly of MSTF on substrate. Hexagonal domain size of MSTFs increased from 36 to 140 nm upon introducing decane in an optimized amount. This process is highly reproducible for growing vertical channels. We should note here that, in addition to MSTF, we also obtained well-suspended MSNs in solution. However, the MSNs that were on the surface of as-synthesized MSTF could be easily removed by sonication and washing.

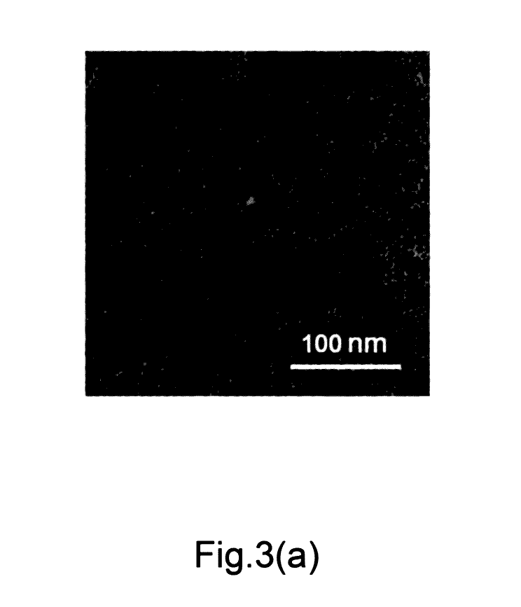

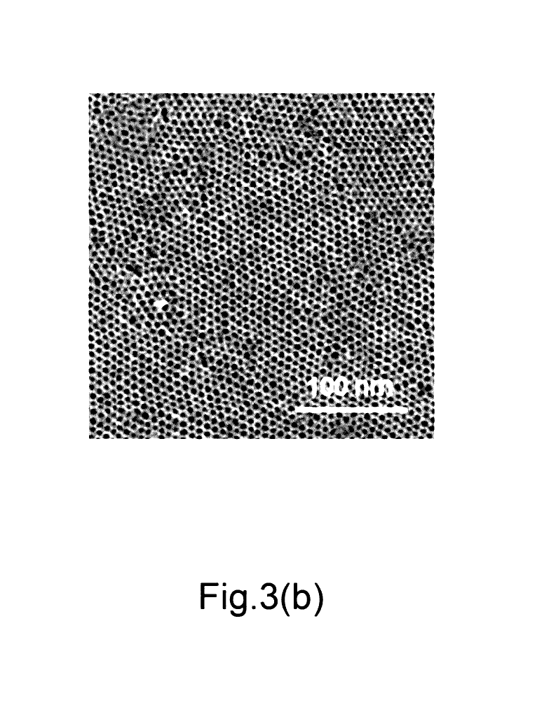

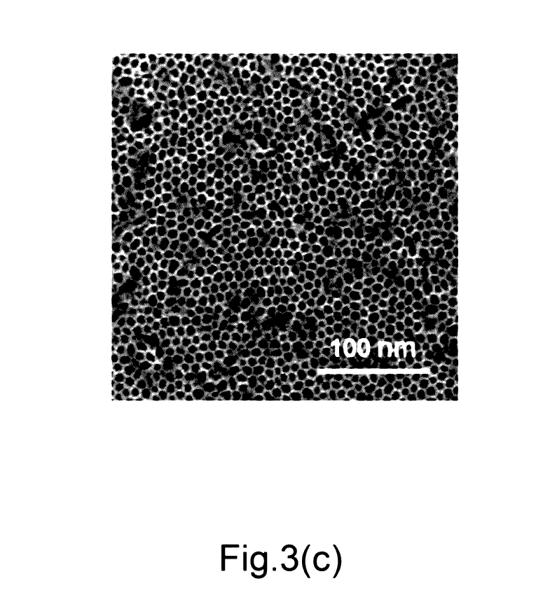

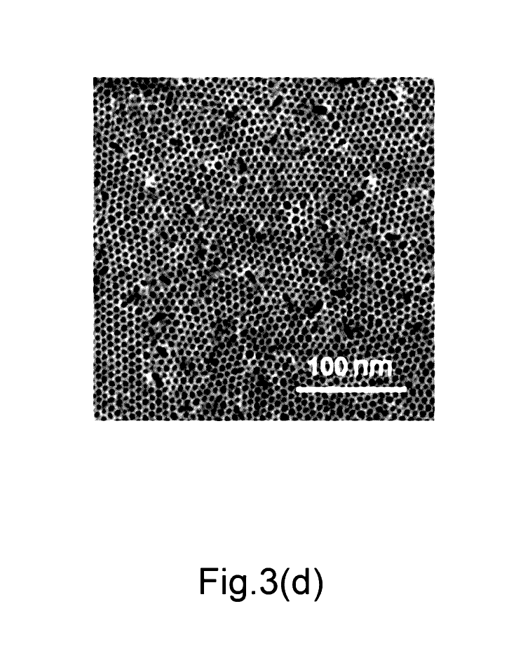

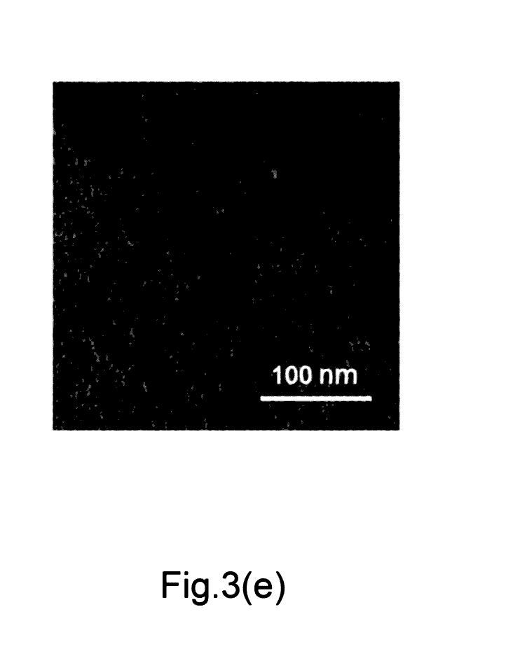

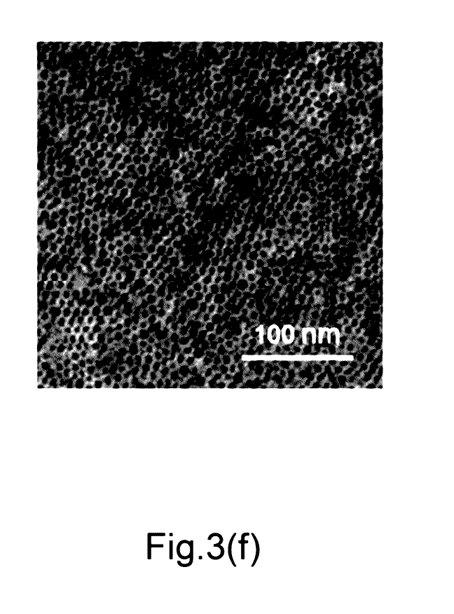

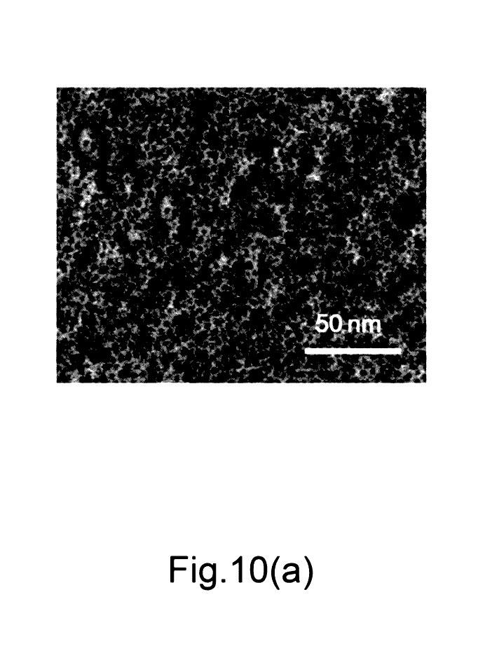

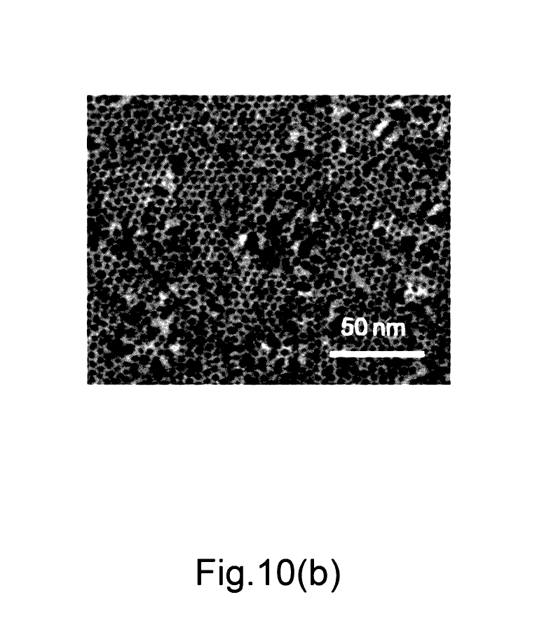

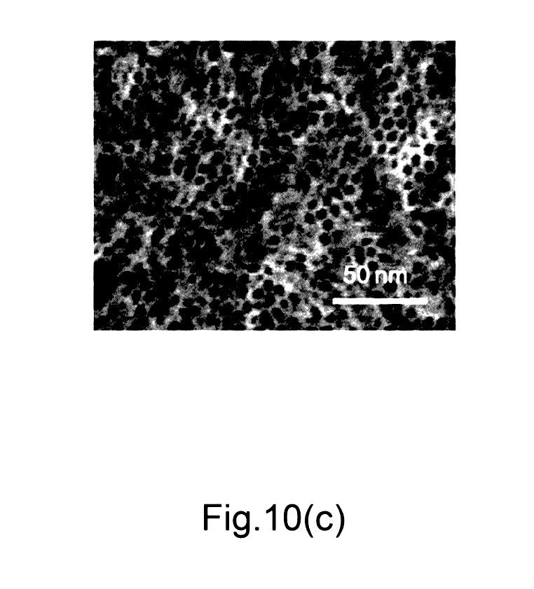

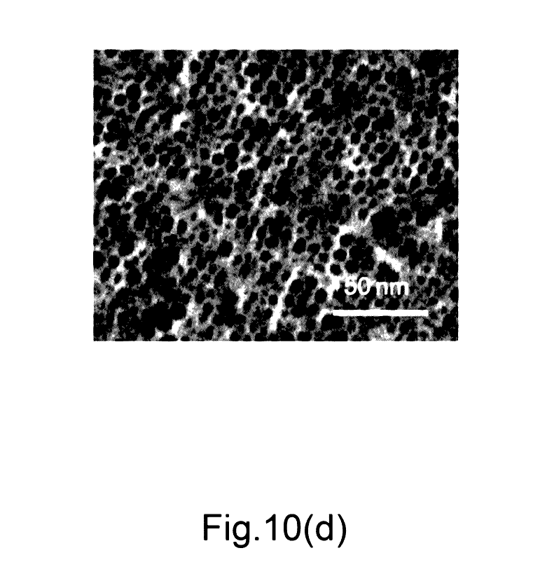

We also performed syntheses with decane replaced by ethyl acetate, hexadecane, petroleum ether, and pentyl ether. Although different pore sizes were obtained (3-8 nm, FIG. 10) as in previous pore-expansion synthesis for MSNs, all the thin films that were deposited on the Si surfaces showed hexagonally ordered mesopores with perpendicular orientation. In addition to the tunable pore expansion, we also employ different silica precursors, including TEOS, fumed silica, and zeolite beta seeds (FIG. 3(a)-FIG. 3(c)), to successfully create vertical mesochannels uniformly on centimeter-wide substrates. To our surprise, this oil-induction synthetic method worked in growing MSTFs onto a wide range of surfaces, from organics and inorganics to even ceramics, always with perpendicular pore orientation. FIG. 3(d)-FIG. 3(f) gives top-view SEM images of the MSTFs, with substrates being piranha solution-washed Si wafer (contact angle=53.2°), tert-butyltrichlorosilane-functionalized Si wafer (contact angle=93.7°), and polystyrene-coated Si wafer (contact angle=85.4°), respectively.

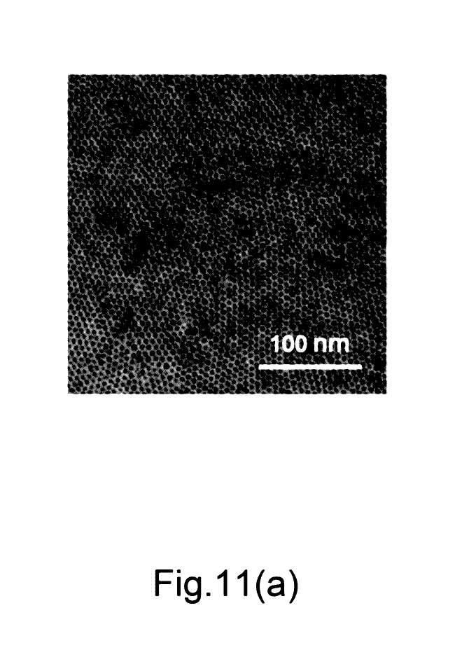

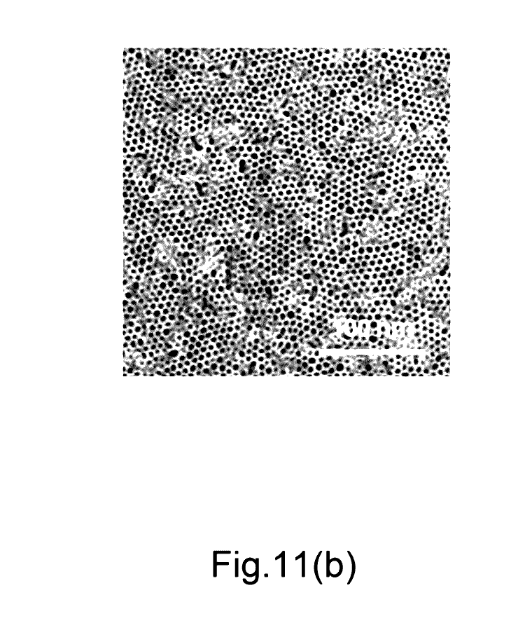

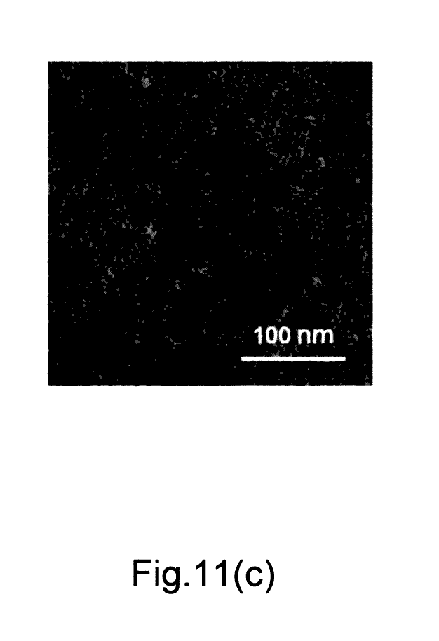

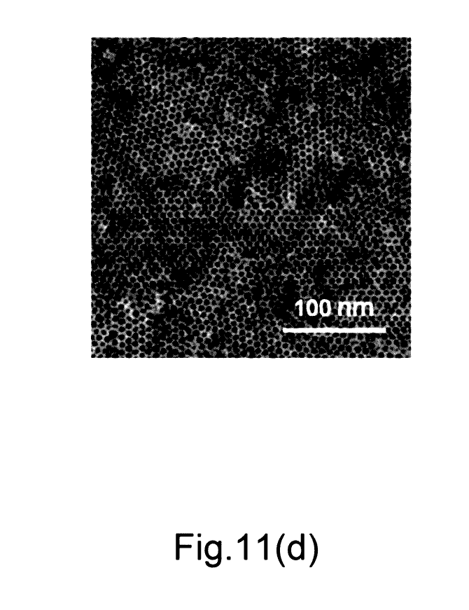

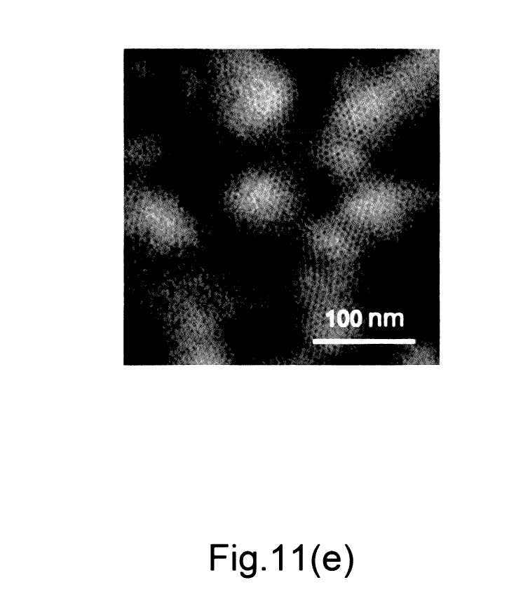

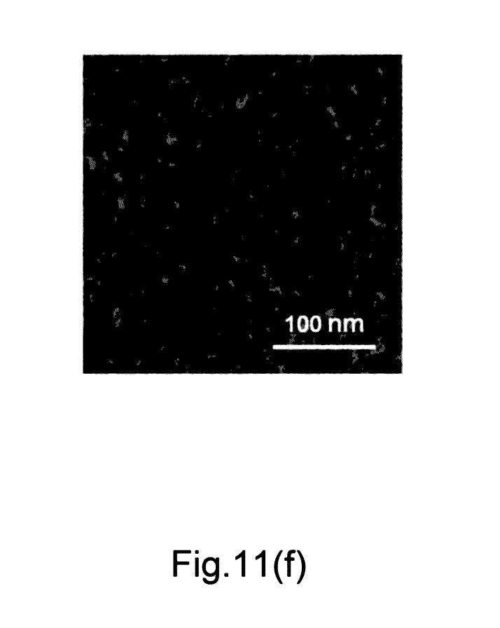

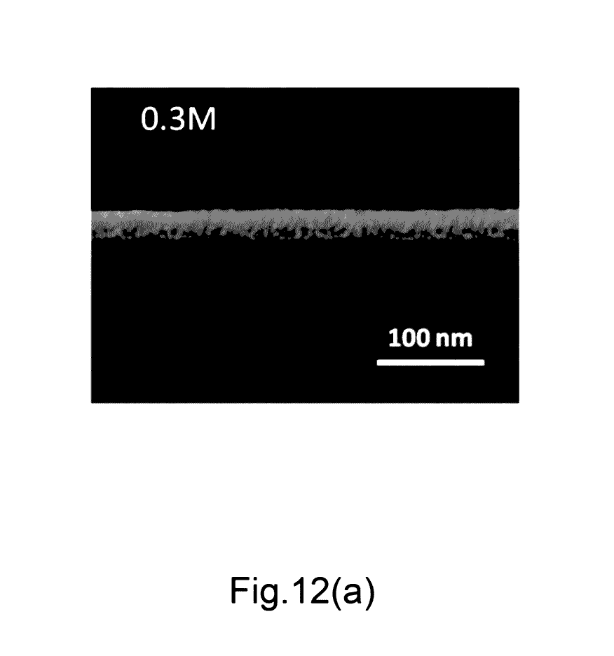

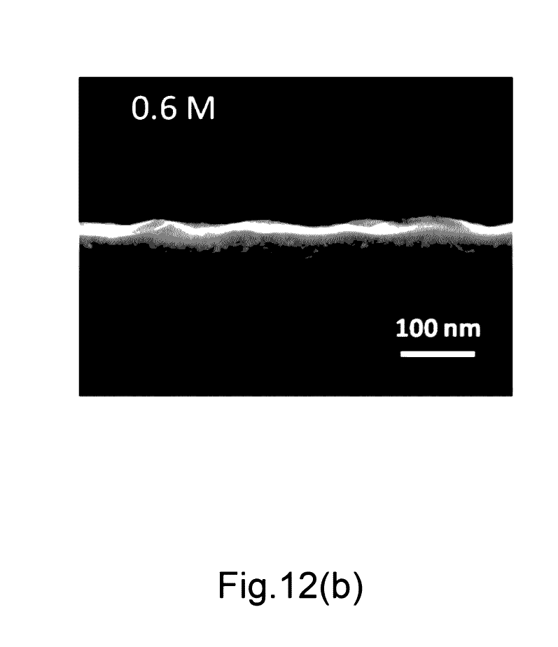

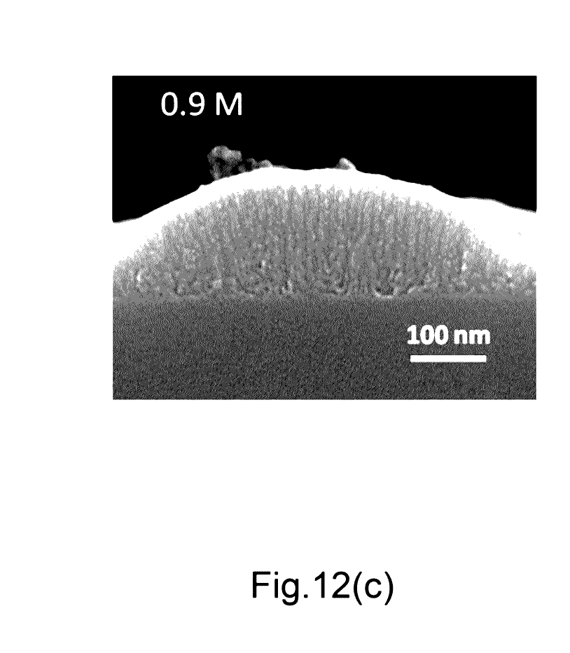

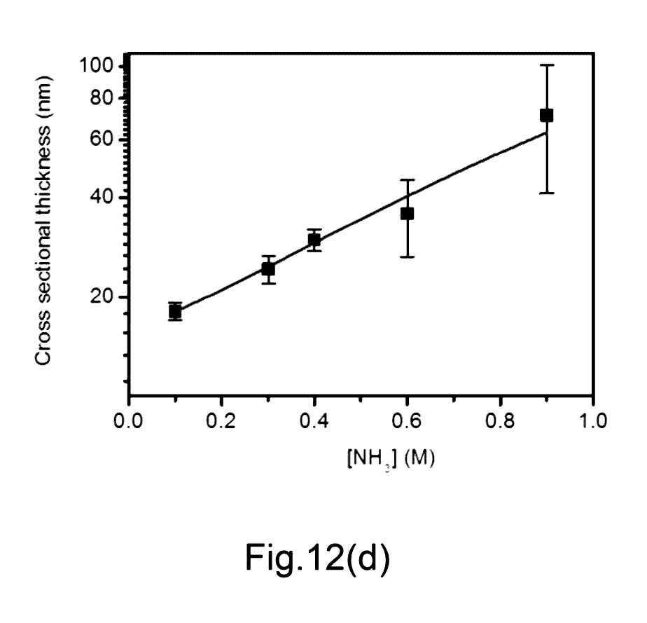

Decane (and other oily agents) seems to be serving as a structure-directing agent to align vertical orientation of the nanochannels onto chemically treated substrates of various degrees of hydrophobicity, α-aluminum oxide (sapphire), and conducting glasses such as ITO and fluorine doped tin oxide(FTO) (FIG. 11). With TEOS as silica source and decane as the pore expansion agent, we also tuned the pH value by using different ammonia concentrations (0.1-0.9 M), resulting still in vertical mesochannel orientation. Increasing the concentration of ammonia gave increased lateral hexagonal domains (coherence lengths) and film thickness, but decreased the uniformity of the thickness of MSTF (FIG. 12). The most uniform and coherently structured film at 30 nm thick was obtained at an ammonia concentration of 0.4 M. For all the substrate surfaces used in this work, the resulting MSTF sticks really very well. Under high shear flow, sonication, or scratching, we have never observed any peeling behavior.

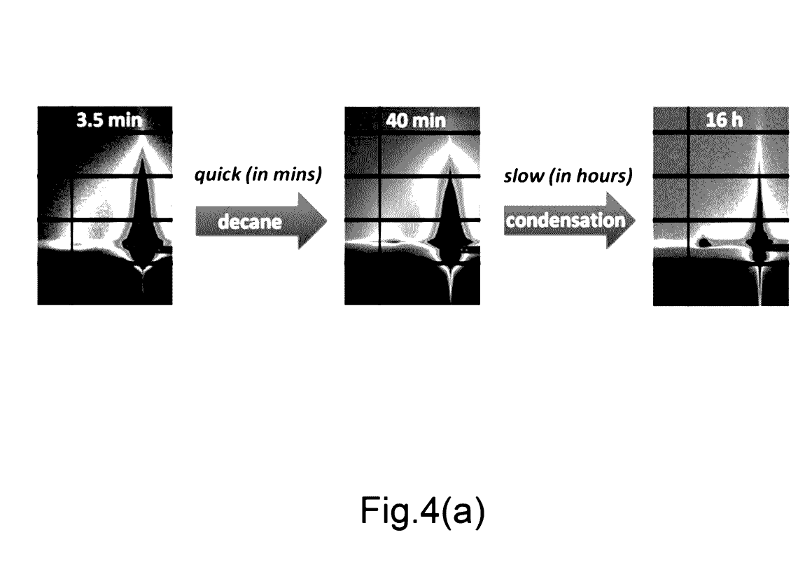

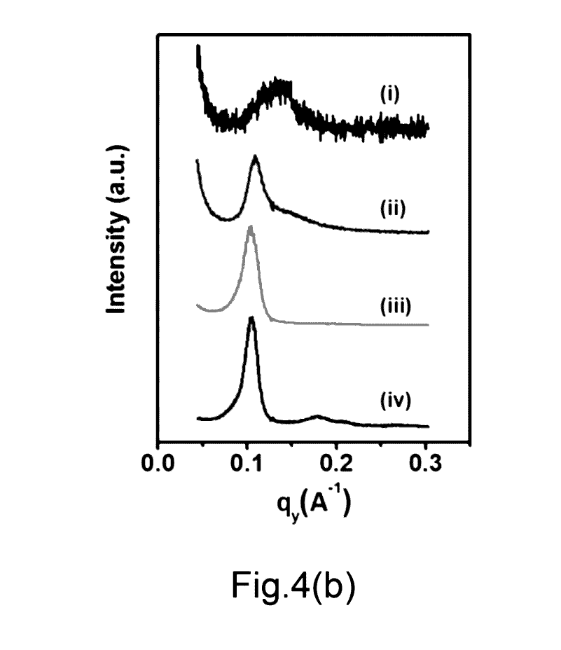

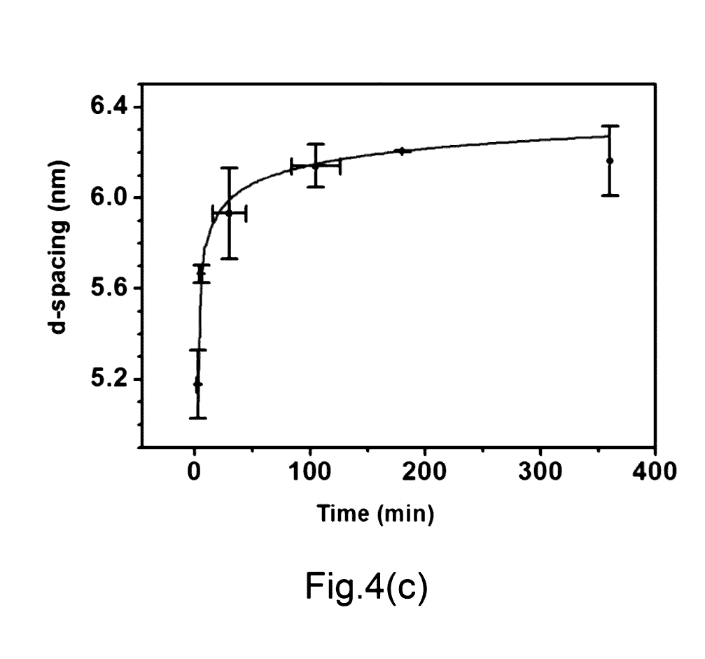

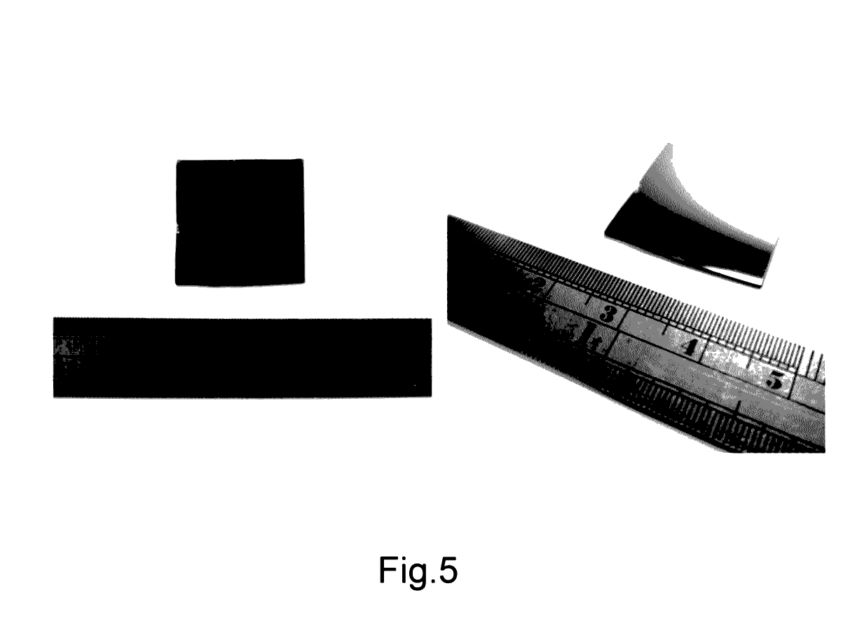

To understand the co-assembly process of decane during the growth, we perform GISAXS experiments to elucidate time evolutions of the structures of mesochannel assemblies. We monitored d-spacing values from in-plane signals proportional to the spacing of pore sizes plus wall thickness. In the first 40 min, a ring of Bragg peaks in GISAXS (FIG. 4(a))was observed, indicating isotropic orientation. They gradually transform into a triangle-shaped in-plane signal, and eventually to a focused spot in the x,y plane, indicating a transformation of nanochannel orientations into an ordered and perpendicular phase. At the same period, the transformation was accompanied by a pore expansion (FIG. 4(c)) during the growth of vertical nanochannels. Pore diameters continually expand a little after the Bragg peaks are well developed (FIG. 4(b), i-iii). If we collect the freshly developing hexagonal phases within the first 120 min, they were not structural stable and rapidly disassembled into an amorphous phase upon ethanol rinsing. To increase the stability, additional aging (4-24 h) at the same temperature and solution conditions is required to fully condense silicate frameworks which are stable to subsequent washing and calcination.

The present invention showed that the thickness of the film was almost constant throughout the period of pore expansion and orientation transformation (FIG. 6). This implies that decane was outside and nearby the film in the beginning and silica condensation helps the solubilization of decane into the micelle-silica complex. We thus propose that in the beginning a thin-film-containing micelle and silica sol was confined by oil while wetting on substrate. The infiltration of oil into the micelle-silica composite drove the transformation into vertical orientation. This model allows a symmetric boundary of the film which is isolated from the surface of the substrate. Thus, it explains the seemingly indifference to the nature of surface. In a way, the mechanism is similar to the one for the free-standing SBA-15 platelet in our work where the confining media was surfactant bilayers instead of oil. Here, the oil can wet and spread on most kind of substrates. The initial fluid-like thin film makes the film very smooth. We also note the condensation-driven phase transformation mechanism proposed here is quite different from the kinetic growth picture in the past method.

In conclusion, we report a general method to grow vertical MSTF from three different silicate precursors on a wide range of (from hydrophilic to hydrophobic) substrates. A facile introduction of decane (or other oils) not only regulates pore diameters but also orientates the growth direction of mesochannels perpendicularly, as revealed by top-view and cross-sectional SEM and TEM images and with grazing incident small-angle X-ray scattering results. High-quality vertical thin films are grown over centimeter domains with film thickness of ca. 30 nm and pore diameter of 5.7±0.5 nm. Diameters of the hexagonally arranged mesopores increase with decane amounts (to a limiting value) as well as reaction time.

### EXAMPLE 4

### Growth of Gold Nanoparticles Arrays on Mesoporous Silica

In a 5 ml of HAuCl₄ aqueous solution (2.5×10⁻⁴M), APTMS-functionalized MSTF and spin-coated MSN were immersed in the solution and shaken at room temperature (˜25° C.) for 3 h. Then, with an introduction of 600 μl of ice-bath NaBH₄ solution (2.4 mM), gold nanoparticles were reduced and the mesoporous silica-gold nanocomposites were kept aging in the solution for 1 h. The nanocomposites were rinsed by water and dried in vacuum.

Characterization:

Scanning electron microscopy(SEM) images were taken on a field emission scanning electron microscope (Hitachi S-4800) Transmission electron microscopy (TEM)images was performed on a transmission electron microscope (Hitachi H-7100) Solution UV-Vis absorption spectra were carried out on a Hitachi U-3010 spectrophotometer. A Zeiss Axiovert 200 MAT inverted microscope equipped with a spectrometer (Horiba iHR320) was used for the acquisition of dark-field scattering spectra.

The scattering spectra were calibrated using a white standard (WS-1-SS, Mikropack). Powder X-ray diffraction patterns were obtained on a Scintag X1 diffractometer with Cu Kα radiation at λ=0.154 nm. Nitrogen adsorption-desorption isotherms were collected on a Micrometric ASAP 2010 apparatus at 77 K. Elemental analyses were carried out on an element analyzer of elementarvario EL cube (Germany). The amounts of CHN on APTMS-functionalized mesoporous silica materials were measured twice for each sample. Hydrodynamic nanoparticle sizes were measured using dynamic light scattering (DLS) on a Nano ZS90 laser particle analyzer (Malvern instrument, UK). Zeta potential of bare gold nanoparticles were collected on the same instrument of DLS with an electrode cells.

### EXAMPLE 5

### Raman Measurements

MSTF-Au and MSN-Au were immersed in 1 ml of 4-MBA/methanol or R6G aqueous solutions with different concentrations (10 μM-1 nM) After 19 h, samples were rinsed with methanol or water and dried in vacuum prior to Raman measurements. SERS spectra were collected using an Micro-Raman spectrometer (Horiba JobinYvon's HR800) equipped with a CCD (3 Mega Pixel) and a 633-nm laser, with a laser spot size of 0.7 mm and a beam power density of 15 mW cm⁻². The integration time was 15 s for each spectrum. SERS enhancement factor (EF) was calculated from the following equation: EF=(I_{SERS}/C_{SERS})/(I_{ref}/C_{ref}), where I_{SERS} denotes the intensities of the SERS spectra of MSTF-Au and MSN-Au after soaking in the solution of R6G with a concentration of C_{SERS}, and I_{ref} denotes the Raman signals measured on MSTF and MSN substrates after soaking in the solution of R6G with a concentration of C_{ref}. The EFs value were estimated with the same condition of laser power and normalized with acquisition time (15 s for I_{SERS} and 80 s for I_{ref}).

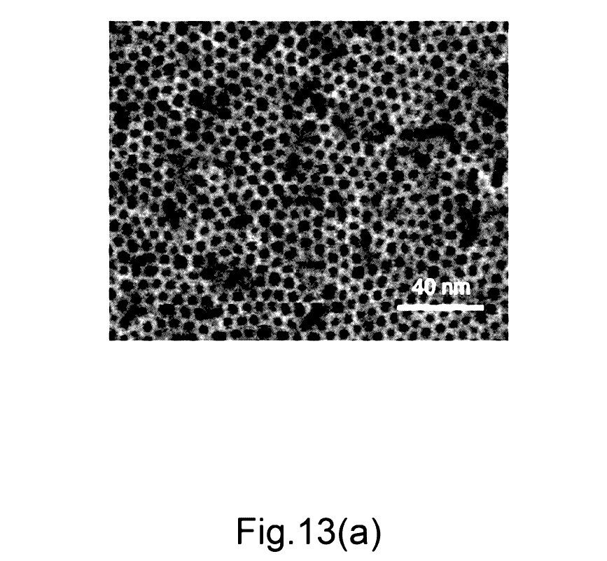

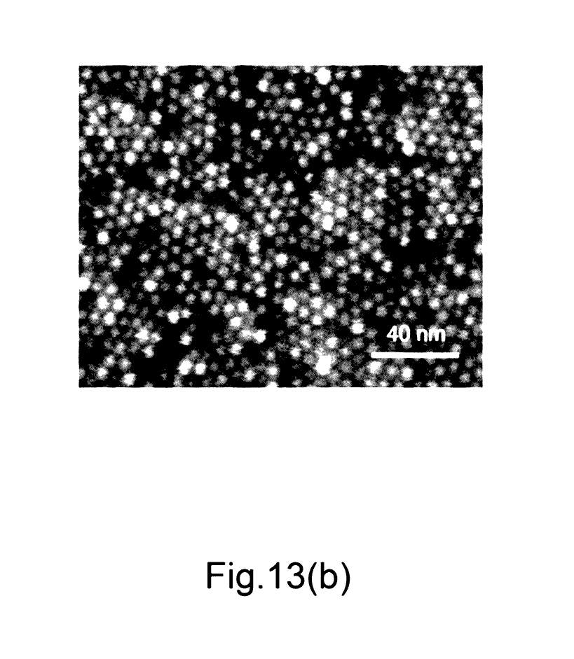

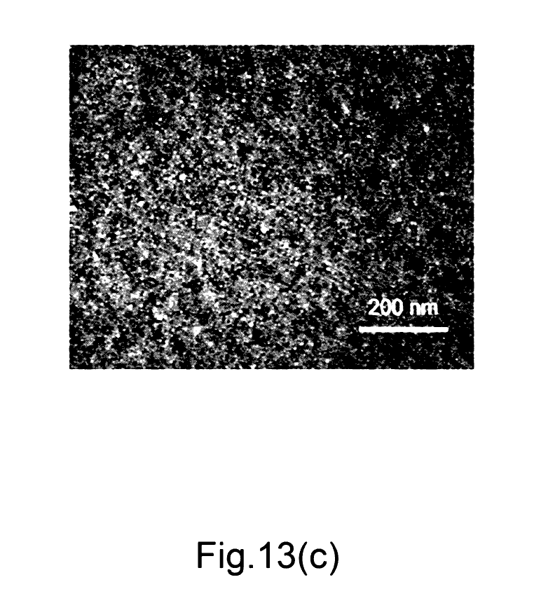

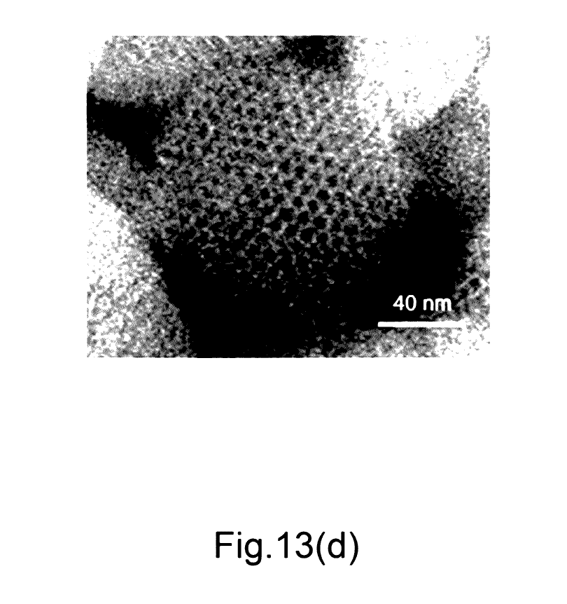

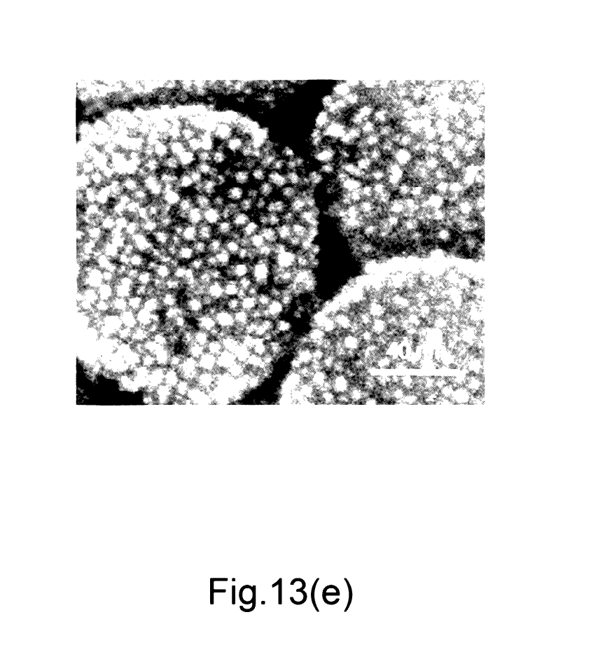

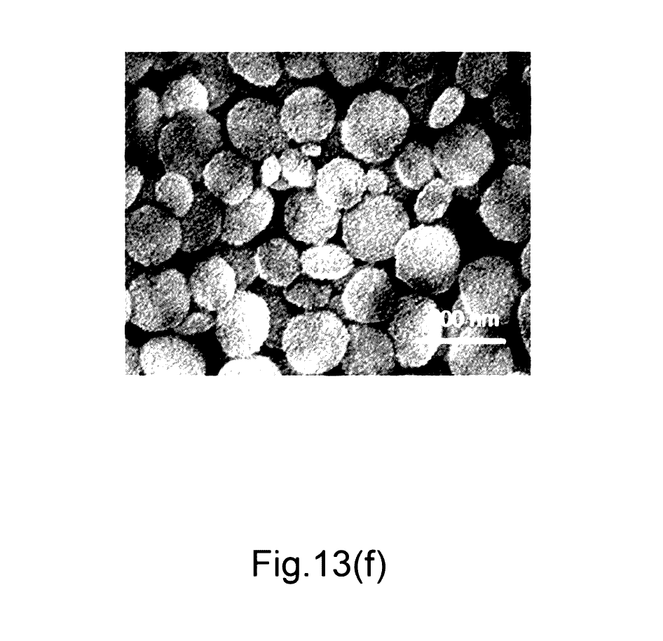

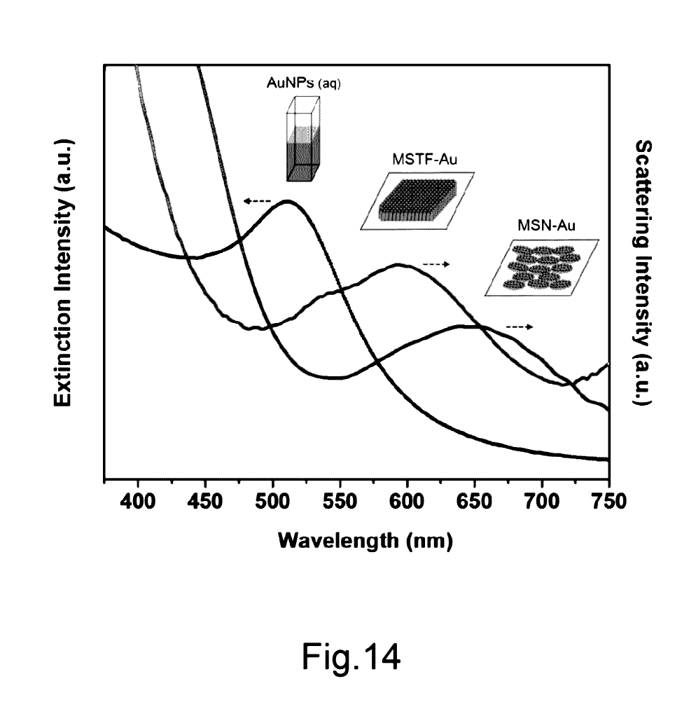

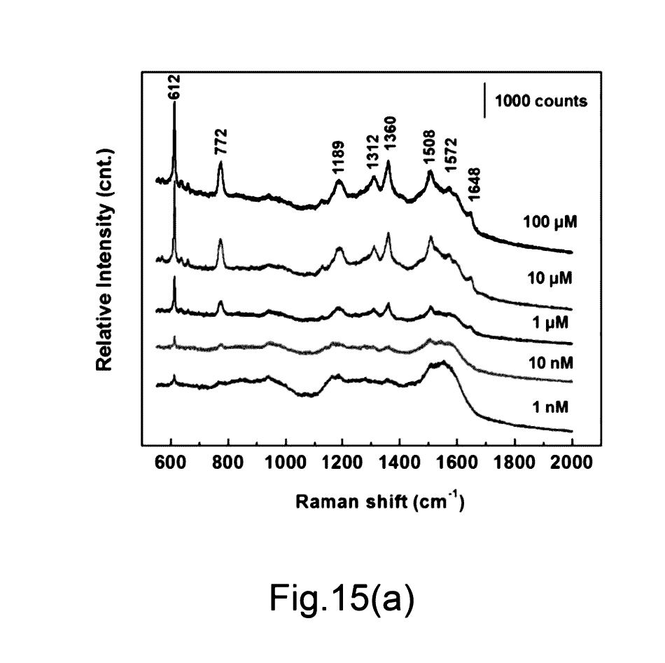

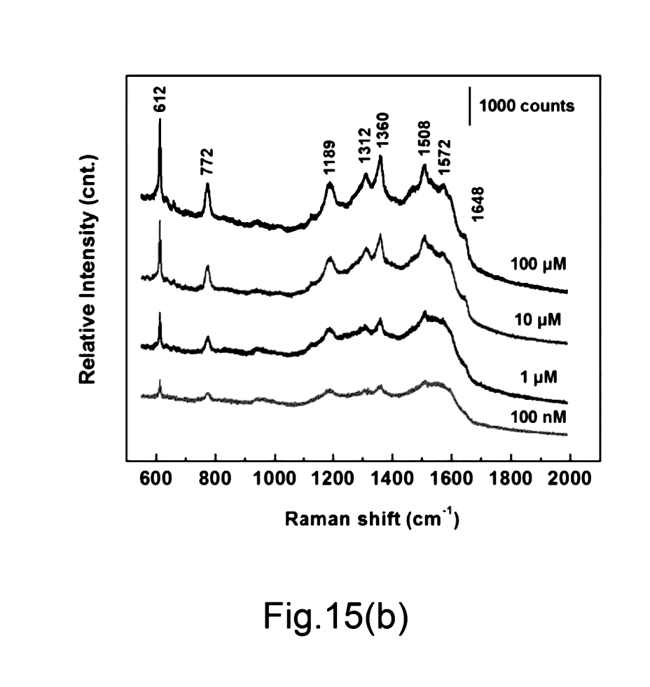

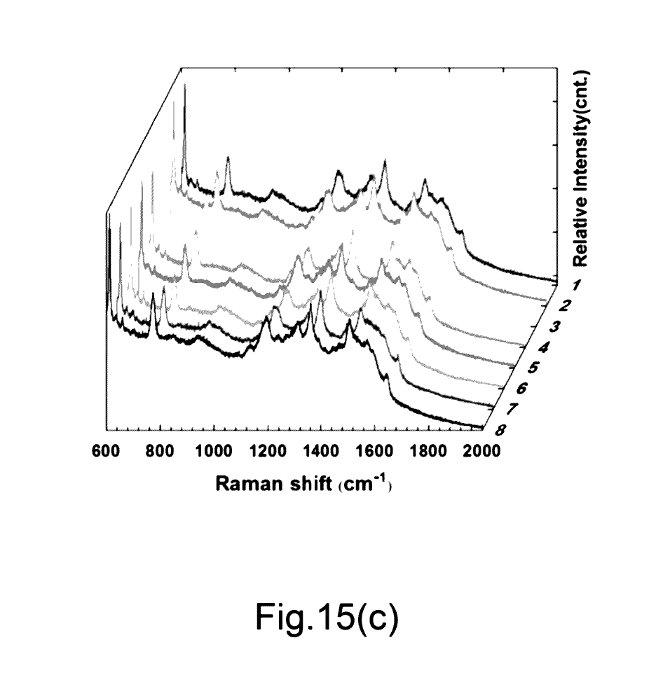

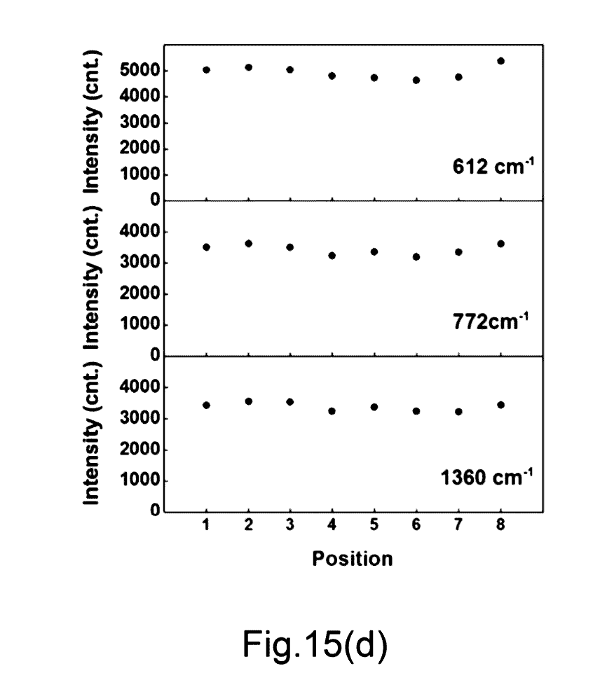

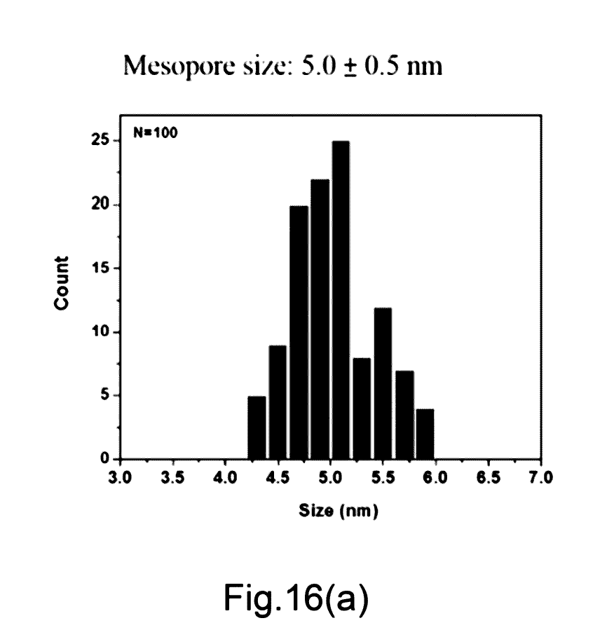

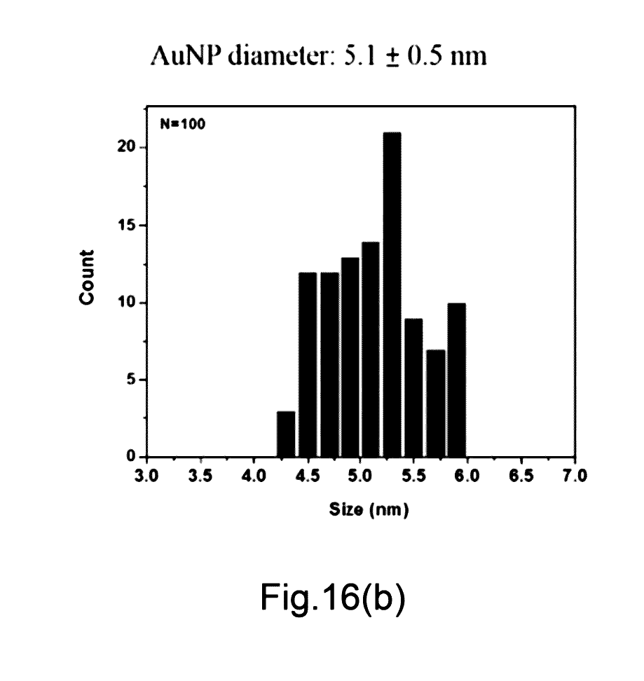

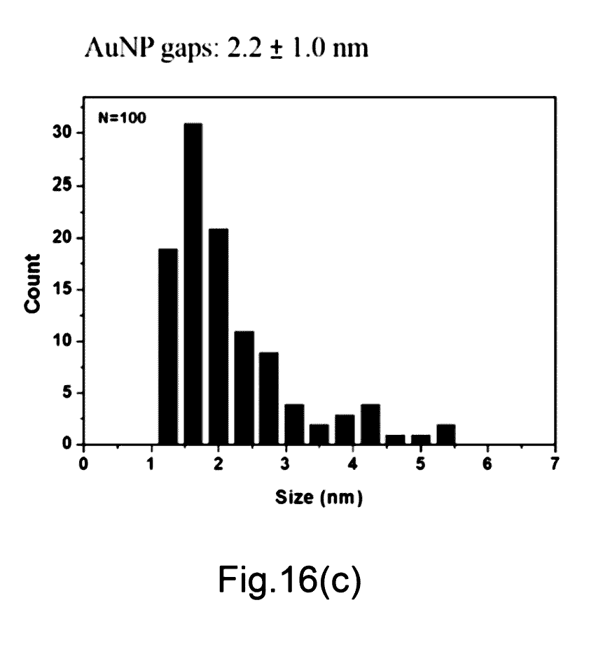

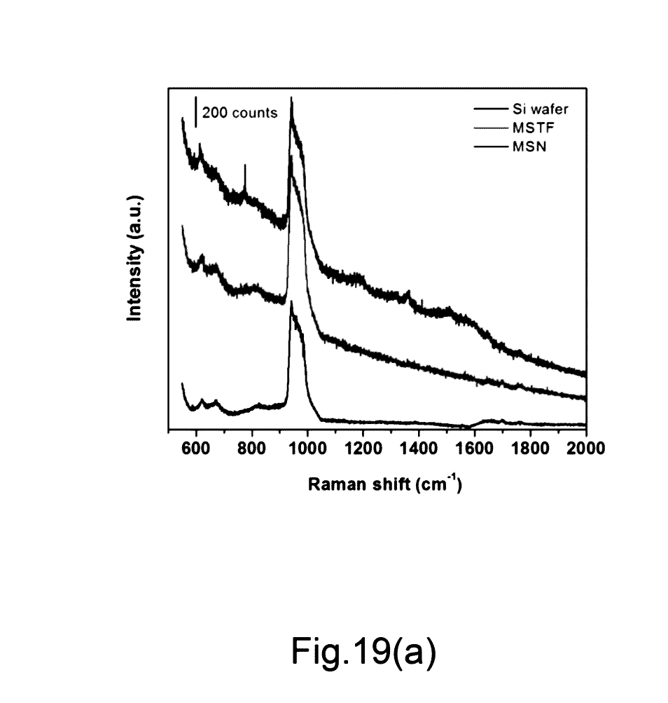

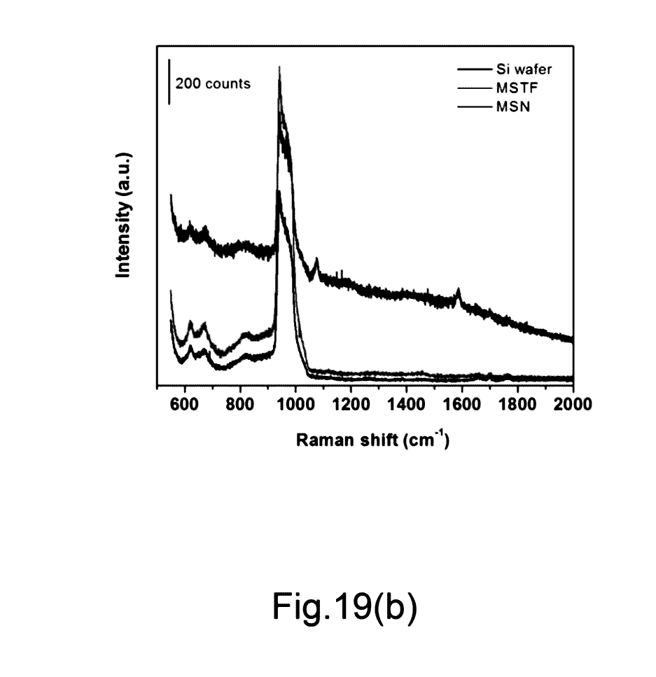

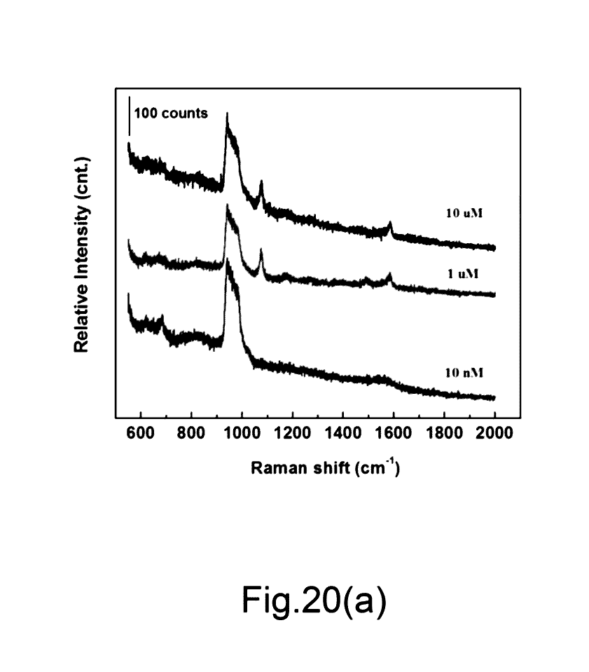

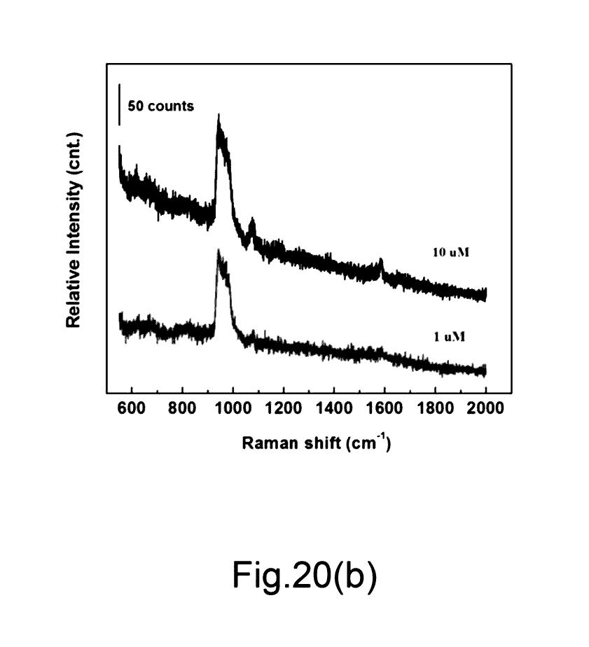

In the present Raman measurements, a laser (λ=633 nm) with excitation wavelength close to the LSPR of the gold nanoparticles arrays (FIG. 14) was used. The Raman spectra of rhodamine 6G (R6G) adsorbed on MSTF-Au and MSN-Auare shown in FIG. 15. All the nanocomposites were soaked in 1 ml of aqueous R6G solution with various concentrations and were rinsed with water prior to measurements. In the MSTF-Au sample, SERS signal of R6G was detectable even at a concentration as low as 1 nM (FIG. 15(a)). On the other hand, MSN-Au showed a detection limit for R6G at 100 nM. By comparing to the Raman spectra of 1 mM of R6G on MSTF and MSN templates (FIG. 19(a)), the analytical SERS enhancement factor (EF) for R6G on MSTF-Au and MSN-Au were 1.5×10⁷ and 1.9×10⁵, respectively. The ultrasensitive SERS detection was attributed to the strongly enhanced electric fields at the sub-3 nm nanogapshot-spots between hexagonal packed gold nanoparticles. MSTF-Au showed better performance on SERS sensitivity than that of MSN-Au probably because of the more compact nanogaps inferring from the SEM images (FIG. 13). Furthermore, for the sample of MSTF-Au, the SERS signals at 8 different positions (distance=5 μm) displayed in FIG. 15(c) showed uniform intensities with a relative standard deviation of ˜5% (FIG. 15(d)) indicating the great spatial homogeneity of the gold-silica nanocomposites.

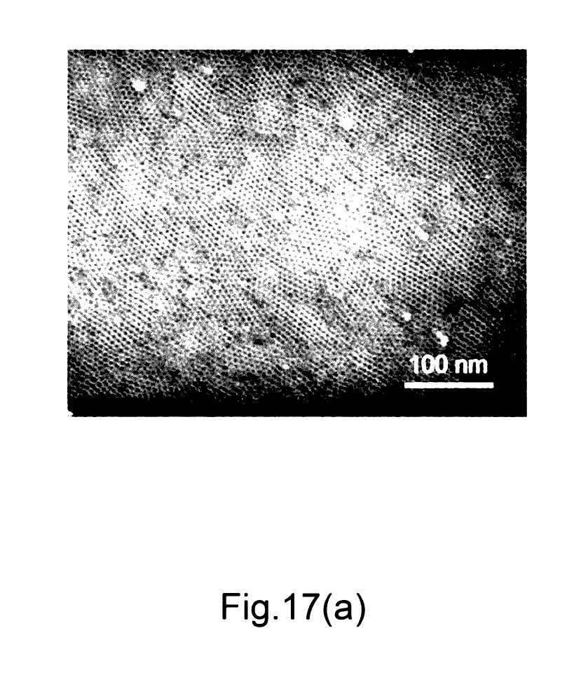

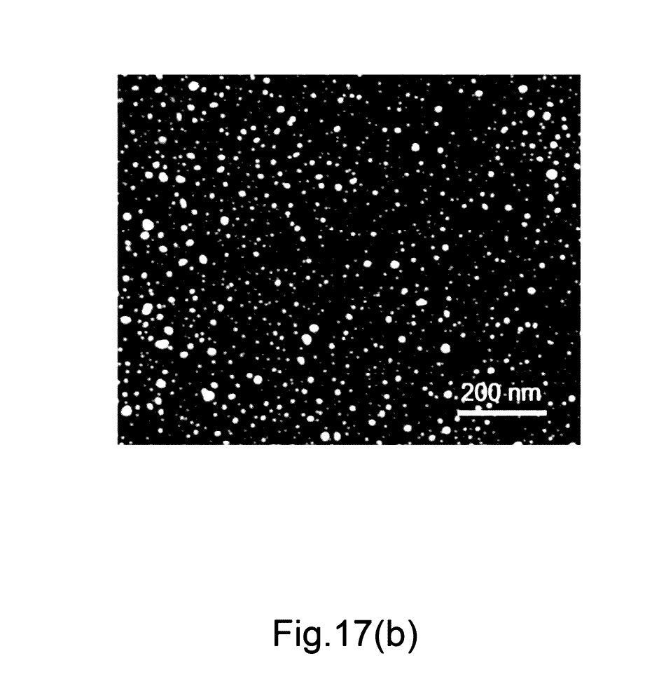

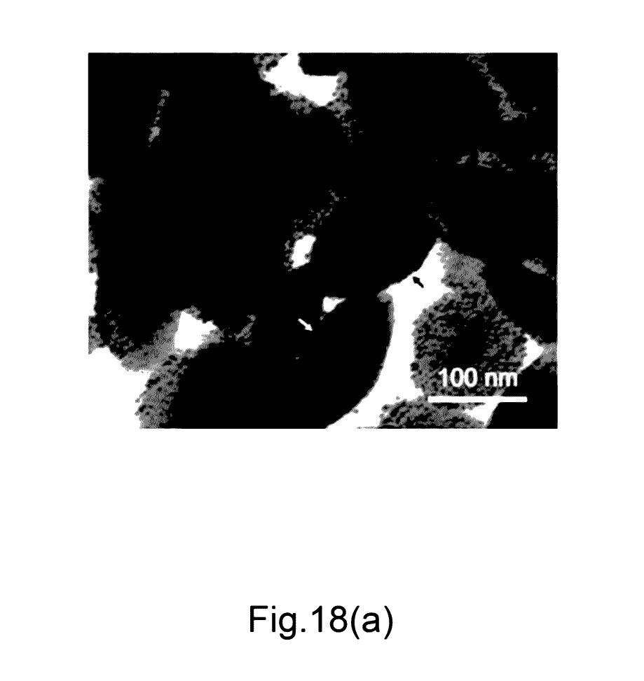

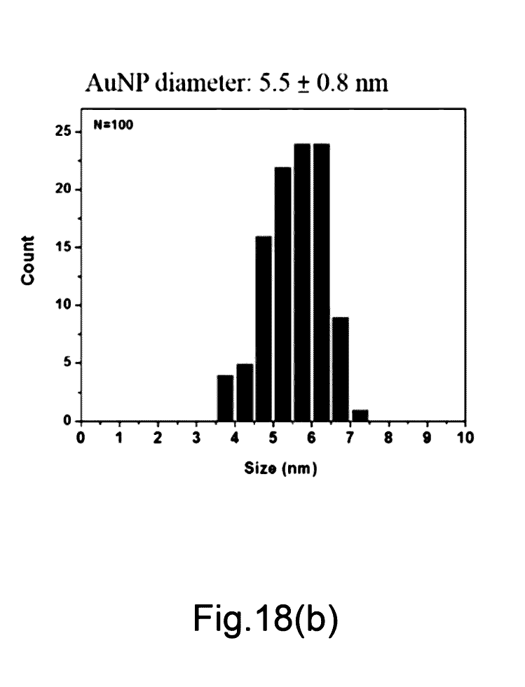

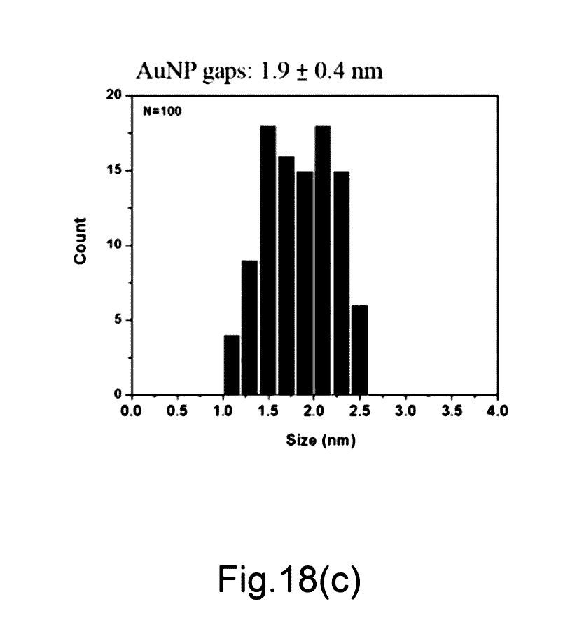

With respect to the formation pathway of 2-D gold nanoparticle arrays using the mesopore-templating method, from the point of chemical reduction, NaBH₄ is as a strong reducing reagent, can quickly nucleate gold nanocrystals inside mesoporous channels which mean while restrict the growing size of nanoparticles due to confinement effect. However, herein, the present invention demonstrated that mesochannels with large pore volumes and an appropriate surface chemistry can also act as nano-reservoirs to accumulate gold precursors. High density of functionalized amino groups in every silica channel appeared strong affinity to adsorb sufficient amount of HAuCl₄ through electrostatic interaction or chemical chelation. Simultaneously, amino groups can also protect the growth of gold nanoparticles during chemical reduction, and thereof achieved in the densely-packed gold nanoparticles anchored on every mesopore. In contrast, when it comes to a diffusion-limited growth on a flat surface, gold precursors would be quickly consumed nearby a site where a nanoparticle just formed, and thus inhibits the growth of other proximal nanoparticles. For example, gold reduction on an APTMS-functionalized Si wafer without mesoporous templates showed sparse gold nanoparticles randomly spread on the substrate with a much wide particle size distribution (FIG. 17(b)). Furthermore, we would like to emphasize the importance of micro-environments inside the silica nanochannels. Trapped solvent like ethanol or toluene during the process of surface functionalization must be removed to facilitate the loading and chemical reduction of gold precursors.

In conclusion, we have developed an efficient method to create large area 2-D gold nanoparticle arrays on well-ordered mesoporous silica (MSTF and MSN) by utilizing a mesopore-templating method. Amino groups functionalized silica surfaces efficiently attracted a quantity of gold precursor into every mesochannel, and thus every nano-reservoir provided enough gold resource for achieving a nanoparticle array during chemical reduction. From SEM images, highly uniform close-packed gold nanoparticles with diameter of 5.1 nm anchored on each individual mesopores lead to ultra small nanogaps below 3 nm. Dark-field scattering spectra of MSTF-Au and MSN-Au showed red-shifted LSPR signals (λ=600-650 nm) indicating the plasmonic coupling effect between close-packed gold nanoparticles. The strongly enhanced electric fields between the sub-3 nm nanogaps make the gold nanoparticle arrays excellent SERS-active substrates. The MSTF-Au and spin-coated MSN-Au on silicon wafers demonstrated SERS EFs of 1.5×10⁷ and 1.9×10⁵ for R6G, respectively. These facile on-substrate SERS nanocomposites, especially the MSTF-Au which showed exceptional spatial uniformity with an ultrasensitive SERS detection limit down to 1 nM, will promise useful applications in label-free chemical sensing and bio-sensing

While the invention has explained in relation to its preferred embodiments, it is well understand that various modifications thereof will become apparent to those skilled in the art upon reading the specification. Therefore, the invention disclosed herein intended to cover such modifications as fall within the scope of the appended claims.

What is claimed is:

1. A process of forming a mesoporous silica thin film with perpendicular nanochannels on a substrate, said process comprising:
(1). Providing a substrate;
(2). Providing an ammonia solution which comprises a tertiary alkyl ammonium halide, alcohol, and an additive;
(3). Immersing the substrate into the ammonia solution;
(4). Introducing a silica precursor into the ammonia solution; and
(5). Performing a heating step to form a mesoporous silica thin film with perpendicular nanochannels on the substrate, wherein the mesoporous silica thin film with perpendicular nanochannels having a film thickness between 20 nm and 100 nm, a pore diameter of the perpendicular nanochannels which is between 2 nm and 10 nm and a area more than 500 um×500 um in SEM analysis.

2. The process according to claim 1, said process further comprising a washing step, wherein the washing step is to stabilize the mesoporous silica thin film with perpendicular nanochannels on the substrate by using a buffer which comprises HF/NH₄F.

3. The process according to claim 1, wherein the additive is selected from one of the group consisting of decane, ethyl acetate, petroleum ether, hexadecane, pentyl ether and the combination thereof and a concentration of the additive is between 0.001M and 0.3M.

4. The process according to claim 1, wherein the substrate comprises a silicon wafer, a polystyrene-coated silicon wafer, a ceramic, aluminum oxide, tert-butyltrichlorosilane-functionalized Si wafer, indium tin oxide (ITO), fluorine doped tin oxide (FTO), sapphire surfaces and a conducting glass.

5. The process according to claim 1, wherein the ammonia concentration of the ammonia solution is between 0.05 M and 1.5M.

6. The process according to claim 1, wherein the tertiary alkyl ammonium halide is cetyltrimethylammonium bromide.

7. The process according to claim 1, wherein the silica precursor comprises tetraethyl orthosilicate, fumed silica, and zeolite beta seeds.

8. A mesoporous silica thin film with perpendicular nanochannels, said mesoporous silica thin film with perpendicular nanochannels having a film thickness between 20 nm and 100 nm, a pore diameter of the perpendicular nanochannels which is between 2 nm and 10 nm, and a 2D hexagonal packing diffraction pattern with the space group of p6mm in FFT-SEM analysis.

9. The mesoporous silica thin film with perpendicular nanochannels according to claim 8, said mesoporous silica thin film with perpendicular nanochannels having a out-of-plane (q_{z}) and in-plane (q_{y}) converted line diagram as shown in FIG. 9(b), wherein the out-of-plane (q_{z}) and in-plane (q_{y}) converted line diagram is derived from GISAXS image patterns.

10. The mesoporous silica thin film with perpendicular nanochannels according to claim 8, wherein the pore diameter of the perpendicular nanochannels is between 5 nm and 10 nm.

11. The mesoporous silica thin film with perpendicular nanochannels according to claim 8, being on part or all of surfaces of at least one selected from a membrane, a semiconductor, a catalyst, a sensor and an energy conversion device.

12. A process of making a gold nanoparticle array on a mesoporous silica material with perpendicular nanochannels, said process comprising
(1). Providing a mesoporous silica material with perpendicular nanochannels selected from one of the groups consisting of a mesoporous silica thin film and a mesoporous silica nanoparticle;
(2). Performing a reaction to have the mesoporous silica material with perpendicular nanochannels react with an amino functional group introducing agent to give an amino functionalized mesoporous silica material with perpendicular nanochannels;
(3). Immersing the amino functionalized mesoporous silica material with perpendicular nanochannels into a gold precursor solution to coat gold ions onto the amino functionalized mesoporous silica material with perpendicular nanochannels; and
(4). Performing a reduction reaction to reduce the gold ions to gold nanoparticles, so as to form the gold nanoparticle array on the mesoporous silica material with perpendicular nanochannels, wherein the gold nanoparticles directly anchored on the perpendicular nanochannels, wherein a pore diameter of the perpendicular nanochannels is between 2 nm and 10 nm.

13. The process of making a gold nanoparticle array on a mesoporous silica material with perpendicular nanochannels according to claim 12, wherein the gold nanoparticle having a diameter between 3 nm and 30 nm.

14. The process of making a gold nanoparticle array on a mesoporous silica material with perpendicular nanochannels according to claim 12, wherein gap distances between the gold nanoparticles on the mesoporous silica material with perpendicular nanochannels is less than 3 nm.

15. The process of making a gold nanoparticle array on a mesoporous silica material with perpendicular nanochannels according to claim 12, wherein the amino functional group introducing agent comprises (3-aminopropyl)trimethoxysilane.

16. The process of making a gold nanoparticle array on a mesoporous silica material with perpendicular nanochannels according to claim 12, wherein the gold precursor solution comprises 0.01 mM-5 mM of HAuCl₄.

17. The process of making a gold nanoparticle array on a mesoporous silica material with perpendicular nanochannels according to claim 12, wherein the reduction reaction is performed with 0.1 mM-10 mM of sodium borohydride.

18. The process of making a gold nanoparticle array on a mesoporous silica material with perpendicular nanochannels according to claim 12, wherein the gold nanoparticle array on a mesoporous silica material with perpendicular nanochannels is applied in label-free chemical sensing and biosensing.
